(19) United States
(12) Patent Application Publication
(10) Pub. No.: US 2024/0137952 A1
(43) Pub. Date: Apr. 25, 2024

(54) HARQ-ACK TRANSMISSION

(71) Applicant: Intel Corporation, Santa Clara, CA (US)

(72) Inventors: Yingyang Li, Beijing (CN); Gang Xiong, Portland, OR (US); Daewon Lee, Portland, OR (US); Alexei Davydov, Nizhny Novgorod (RU); Prerana Rane, Newark, CA (US)

(21) Appl. No.: 18/548,205

(22) PCT Filed: Feb. 28, 2022
(86) PCT No.: PCT/US2022/018160

§ 371 Date: Aug. 27, 2023

Related U.S. Application Data
(60) Provisional application No. 63/155,670, filed on Mar. 2, 2021.
(60) Provisional application No. 63/186,721, filed on May 10, 2021.
(60) Provisional application No. 63/215,837, filed on Jun. 28, 2021.

(30) Foreign Application Priority Data
Mar. 17, 2021 (WO) PCT/CN2021/081492
Mar. 17, 2021 (WO) PCT/CN2021/081509

(51) Int. Cl. H04W 72/232; H04L 1/1812; H04W 72/1273; H04W 76/28

(52) U.S. Cl. CPC H04W 72/232; H04L 1/1812; H04W 72/1273; H04W 76/28

(57) ABSTRACT

Various embodiments herein provide techniques related to hybrid automatic repeat request acknowledgement (HARQ-ACK) transmission in cellular networks. Some embodiments may relate to HARQ-ACK transmission in networks that use a relatively high carrier frequency (e.g., a carrier frequency above approximately 52.6 gigahertz (GHz)). Some embodiments may relate to HARQ-ACK codebook size determination for multi-physical downlink shared channel (PDSCH) scheduling. Some embodiments may relate to downlink control and HARQ-ACK transmission for multi-PDSCH scheduling. Other embodiments may be described and/or claimed.

### CROSS REFERENCE TO RELATED APPLICATION

The present application claims priority to U.S. Provisional Patent Application No. 63/155,670, which was filed Mar. 2, 2021; International Patent Application No. PCT/CN2021/081492, filed Mar. 18, 2021; International Patent Application No. PCT/CN2021/081509, filed Mar. 18, 2021; U.S. Provisional Patent Application No. 63/186,721, which was filed May 10, 2021; and U.S. Provisional Patent Application No. 63/215,837, filed Jun. 28, 2021.

### FIELD

Various embodiments generally may relate to the field of wireless communications. For example, some embodiments may relate to hybrid automatic repeat request-acknowledgement (HARQ-ACK) transmission in various cellular network scenarios.

### BACKGROUND

Various embodiments generally may relate to the field of wireless communications.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates an example of a long physical downlink shared channel (PDSCH) transmission duration, in accordance with various embodiments.

FIG. 2 illustrates an example of early termination of a PDSCH transmission, in accordance with various embodiments.

FIG. 3 illustrates an example of an indication of a new transmission or retransmission, in accordance with various embodiments.

FIG. 4 illustrates an alternative example of an indication of a new transmission or retransmission, in accordance with various embodiments.

FIG. 5 schematically illustrates an alternative example of an indication of a new transmission or retransmission, in accordance with various embodiments.

FIG. 6 illustrates an alternative example of an indication of a new transmission or retransmission, in accordance with various embodiments.

FIG. 7 illustrates an example of a last downlink control information (DCI) that includes an uplink grant for scheduling a physical uplink shared channel (PUSCH) or physical uplink control channel (PUCCH) transmission, in accordance with various embodiments.

FIG. 8 illustrates an example of a later DCI that includes an uplink grant for scheduling a PUSCH or PUCCH transmission, in accordance with various embodiments.

FIG. 9 illustrates an example of more than one DCI including an uplink grant for scheduling a same PUSCH or PUCCH transmission, in accordance with various embodiments.

FIG. 10 illustrates an example of a short slot duration of larger subcarrier spacing, in accordance with various embodiments.

FIG. 11 illustrates an example of multi-transmission time interval (TTI) scheduling for PDSCHs, in accordance with various embodiments.

FIG. 12 illustrates an example of the generation of two HARQ-ACK sub-codebooks, in accordance with various embodiments.

FIG. 13 illustrates another example of the generation of two HARQ-ACK sub-codebooks, in accordance with various embodiments.

FIG. 14 illustrates another example of the generation of two HARQ-ACK sub-codebooks, in accordance with various embodiments.

FIG. 15 illustrates an example of direct HARQ-ACK payload size indication, in accordance with various embodiments.

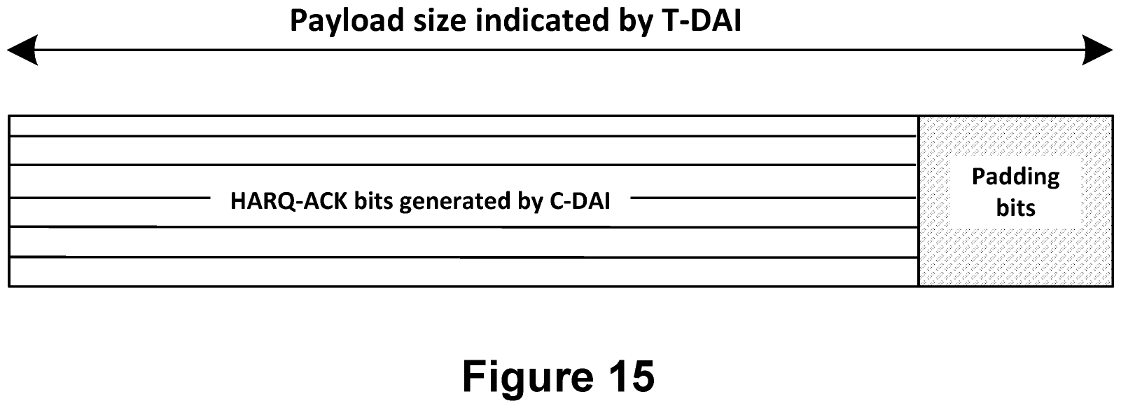

FIG. 16 illustrates an example of a quantized HARQ-ACK payload size by total downlink assignment index (T-DAI), in accordance with various embodiments.

FIG. 17 illustrates an example of the size of downlink assignment index (DAI) fields in a downlink control information (DCI) format, in accordance with various embodiments.

FIG. 18 schematically illustrates a wireless network in accordance with various embodiments.

FIG. 19 schematically illustrates components of a wireless network in accordance with various embodiments.

FIG. 20 is a block diagram illustrating components, according to some example embodiments, able to read instructions from a machine-readable or computer-readable medium (e.g., a non-transitory machine-readable storage medium) and perform any one or more of the methodologies discussed herein.

FIG. 21 depicts an example procedure that may be performed by one or more elements of any of FIGS. 1-20, in accordance with various embodiments.

FIG. 22 depicts an example procedure that may be performed by one or more elements of any of FIGS. 1-20, in accordance with various embodiments.

FIG. 23 depicts an example procedure that may be performed by one or more elements of any of FIGS. 1-20, in accordance with various embodiments.

FIG. 24 depicts an example procedure that may be performed by one or more elements of any of FIGS. 1-20, in accordance with various embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A or B” and “A/B” mean (A), (B), or (A and B).

High Carrier Frequency HARQ-ACK Transmission

Some embodiments may describe or relate to HARQ-ACK transmission in networks with relatively high frequency carriers (e.g., carriers with frequencies at or above approximately 52.6 gigahertz (GHz)).

Specifically, mobile communication has evolved significantly from early voice systems to today's highly sophisticated integrated communication platform. The next generation wireless communication system (referred to as fifth generation (5G) or new radio (NR)) may provide access to information and sharing of data anywhere, anytime by various users and applications. NR may be a unified network/system that target to meet vastly different and sometime conflicting performance dimensions and services. Such diverse multi-dimensional requirements may be driven by different services and applications. In general, NR may evolve based on third generation partnership project (3GPP) long-term evolution (LTE)-Advanced with additional potential new Radio Access Technologies (RATs) to enrich people lives with better, simple and seamless wireless connectivity solutions. NR may enable various devices to be connected by wireless and deliver fast, rich contents and services.

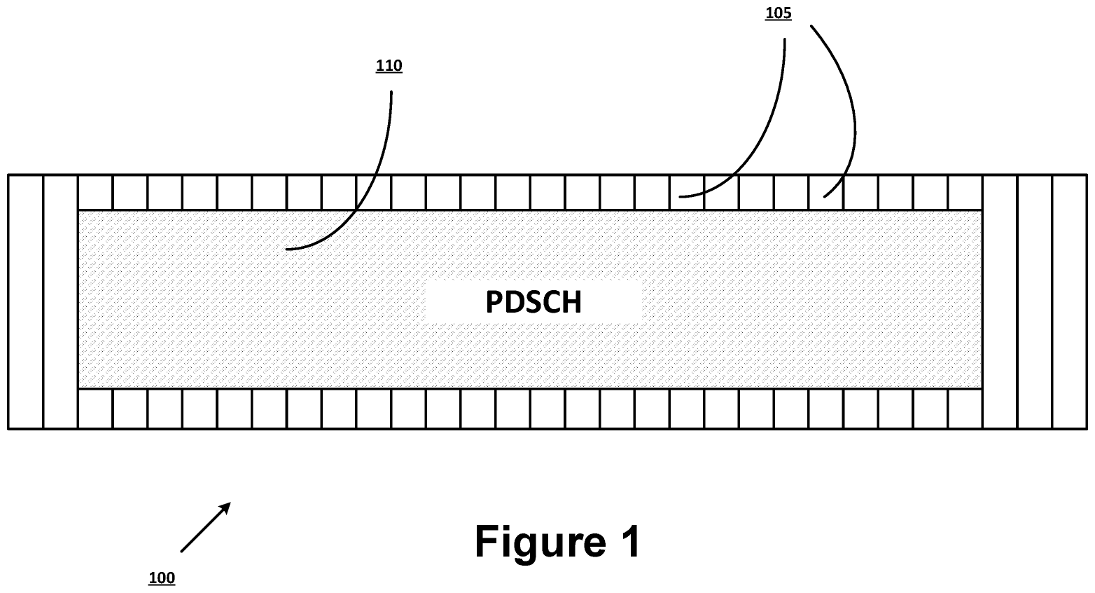

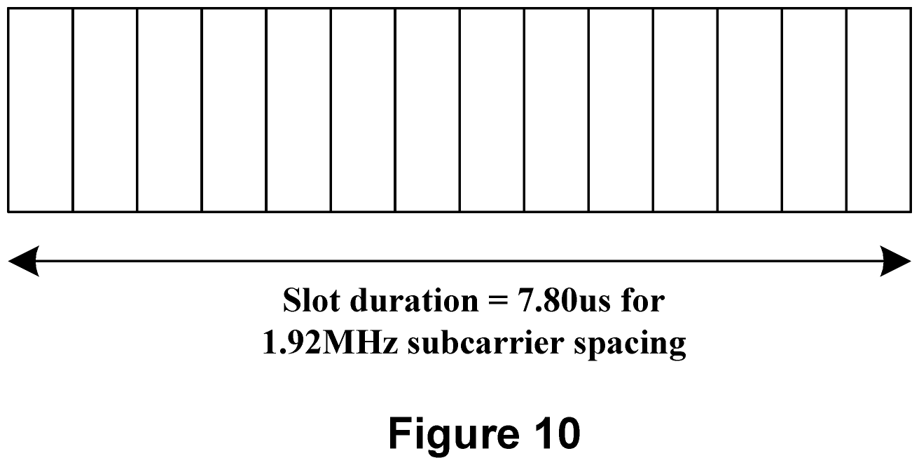

The NR system may operate based on a concept of slot. A physical downlink shared channel (PDSCH) transmission or a physical uplink shared channel (PUSCH) transmission may be restricted within a slot. Such restriction on PDSCH or PUSCH may still apply in high frequency networks. On the other hand, for a system operating above 52.6 GHz carrier frequency, especially for Terahertz communication, a larger subcarrier spacing may be needed to combat severe phase noise. In case when a larger subcarrier spacing, e.g., 1.92 Megahertz (MHz) or 3.84 MHz is employed, the slot duration can be very short. For instance, for 1.92 MHz subcarrier spacing, one slot duration is approximately 7.8 microseconds (ns) as is depicted in FIG. 10. This extremely short slot duration may not be sufficient for higher layer processing, including Medium Access Layer (MAC) and Radio Link Control (RLC), etc. In order to address this issue, a NR base station (gNB) may schedule the downlink (DL) or uplink (UL) data transmission across a slot boundary with a long transmission duration. In other words, the slot concept may not be needed when scheduling data transmission. FIG. 1 illustrates one example 100 of a long PDSCH transmission 110 duration that spans multiple slots 105.

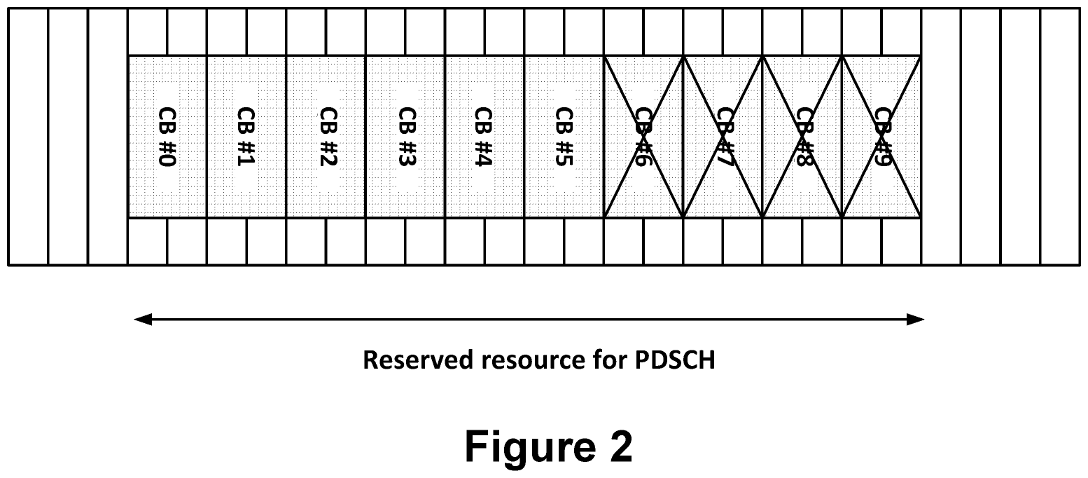

In DL transmission, more DL traffic may arrive at the gNB when the gNB already sends out a DL downlink control information (DCI) or a previous PDSCH transmission is still ongoing. The gNB may have to send a new DL DCI to schedule a PDSCH which results in the delay of data transmissions. One solution may be to allow a gNB to schedule more DL resources than that required to transmit the current DL data in the buffer. Consequently, if new DL traffic arrives, the gNB may continue the PDSCH transmission for the new DL traffic on the scheduled DL resource. Alternatively, if there is no new incoming DL traffic, the scheduled DL resources may need to be released earlier, e.g. early termination of the PDSCH transmission. In fact, besides the case of lacking new DL traffic, there may also exist other reasons that gNB needs to terminate a DL transmission earlier. FIG. 2 illustrates an example for which the allocated DL resources may carry 10 code blocks (CBs) (e.g., CB #0-CB #9). However, the DL transmission may be terminated only after the transmission of 6 CBs. Specifically, as shown in FIG. 2, CB #0-CB #5 may be transmitted while CB #6-CB #9 may not be transmitted.

For the DL or UL transmission in NR, a transport block (TB) from the medium access control (MAC) layer may be transmitted at the physical (PHY) layer. For the hybrid automatic repeat request (HARD) transmission of DL transmission, a single HARQ-ACK bit may be reported by the UE for a TB. Alternatively, if code block group (CBG) based transmission is configured, e.g. a TB is divided into n CBGs, n≤N, N=1,2,4,8, a CBG may include one or more CBs. A CBG transmission indicator (CBGTI) field may be used to indicate whether a CBG is scheduled or not by a DCI. A UE may report n or N HARQ-ACK bits for the TB. One HARQ-ACK bit may be reported for each CBG. N may be the maximum number of CBGs which could be configured by high layer. If a DCI schedules X TBs, there may be X new data indicator (NDI) bits in the DCI. For a system operating above the 52.6 GHz carrier frequency, to support a long PDSCH transmission with or without early termination, an efficient HARQ-ACK transmission scheme may be desirable.

Various embodiments herein provide mechanisms for HARQ-ACK transmission to support a long PDSCH transmission with or without early termination for systems that operate at or above a 52.6 GHz carrier frequency.

In the following descriptions, a downlink or uplink data transmission scheduled by a DCI may include M code block bundles (CBB)s. M may be varied depending on the allocated time resource(s) and/or frequency resource(s). Each CBB may include one or multiple consecutive CBs. Cyclic redundancy check (CRC) may be added for each CB. A CBB may be exclusively mapped to one or more consecutive data symbols. In this way, symbol alignment may be achieved for a CBB. N CBBs can form a CBB bundle, N≥1. One HARQ-ACK bit may be generated per CBB or per CBB bundle. In this sense, CBB bundle can be viewed as CBG in NR. A CBB or CBB bundle may correspond to a MAC PDU or a TB. A separate HARQ process number may be assigned to each CBB or each CBB bundle. CBB may be used in the following descriptions. A CBB can be replaced by a CBB bundle if a HARQ-ACK bit is reported per CBB bundle.

Because the duration of the DL time resource that is allocated by a DCI can be flexible, the number of CBBs scheduled by the DCI may vary accordingly. Consequently, the exact number of HARQ-ACK bits for the DL data transmission may not be fixed. If a fixed number of HARQ-ACK bits are associated with a DCI, the number may be determined by the maximum duration of the schedulable DL time resource, which may result in large overhead in the HARQ-ACK codebook. Therefore, it is preferred for the UE to report the exact number of HARQ-ACK bits for the DL data transmission scheduled by a DCI.

The HARQ-ACK codebook that is transmitted in a UL resource may include the HARQ-ACK bits for the DL data transmission(s) that is/are scheduled by one or more DCIs. The UE may report a discontinuous transmission (DTX) indication for each DCI in a header of the HARQ-ACK codebook. The header may be in the form of a bitmap. Therefore, each bit in the header may indicate whether a corresponding DCI is detected or not. If DTX is not indicated for a DCI in the header, e.g. the DCI is received, the UE may report the exact number of HARQ-ACK bits for the DL data transmission that is scheduled by the DCI. On the other hand, if DTX is indicated for a DCI in the header, e.g. the DCI is not received, no HARQ-ACK bit is included in the codebook for the DCI. For a DL transmission which is terminated earlier, the number of HARQ-ACK bits may still equal to that assuming there is not early termination. Alternatively, the number of HARQ-ACK bits may be derived by the actual number of transmitted CBBs.

The codebook size of the HARQ-ACK codebook may be indicated by the last DCI that indicate the UL resource. For example, Y bits in the last DCI can indicate 2^{Y} different codebook sizes. If the total number of header bits and HARQ-ACK bits is less than the indicated codebook size, padding bits are added to indicated codebook size. If the total number of header bits and HARQ-ACK bits exceeds the indicated codebook size, certain bundling may be applied to reduce the number of HARQ-ACK bits. For example, instead of reporting one HARQ-ACK bit per CBB, the UE may report one HARQ-ACK bits per CBB bundle.

Specifically, the header may not include a bit for the last DCI that indicates the UL resource for HARQ-ACK transmission, because the HARQ-ACK transmission on the UL resource may implicitly indicate that UE received the last DCI.

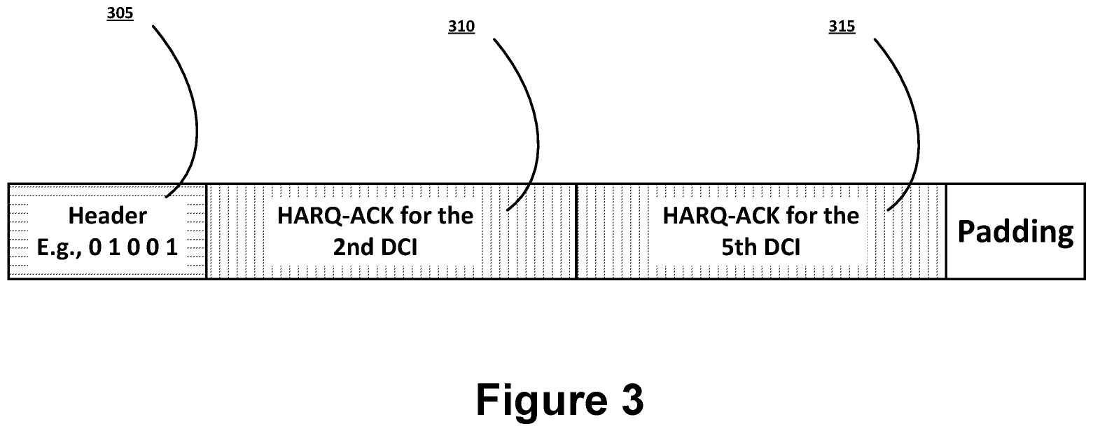

FIG. 3 illustrates an example for the HARQ-ACK codebook generation with DTX indication for the DCIs. It is assumed that maximum 5 DCIs may be received by a UE that schedule DL data transmissions. The UE only detects the second and fifth DCI. Consequently, the UE indicates a header bitmap of ‘0 1 0 0 1’ at 305. Then, the UE includes the HARQ-ACK bits for the DL data transmissions scheduled by the second (at 310) and fifth (at 315) DCI.

In one embodiment, the header may indicate whether one or more DCIs scheduling DL data transmissions are detected in M consecutive configured physical downlink control channel (PDCCH) monitoring occasions (MOs). The PDCCH MOs may be determined by the search space set configuration. The value M may be semi-statically configured by high layer signaling, or dynamically indicated by the last DCI. The header bitmap in the HARQ-ACK codebook may include M bits.
If the value M is configured by a higher layer, it is possible that UE may already report the HARQ-ACK bits corresponding to the DCIs in the beginning m of the M MOs, m<M, and the UE may set the header bit to ‘0’ corresponding to the beginning m MOs. Alternatively, the UE may also report HARQ-ACK bits corresponding to the DCIs in the beginning m MOs in the current HARQ-ACK transmission.
If value M is dynamically indicated in the last DCI, the HARQ-ACK codebook may include HARQ-ACK bits corresponding to any DCI detected within the M PDCCH MOs.

In one option, the M consecutive configured PDCCH MOs are determined relative to the last DCI that schedules DL data transmission for which the HARQ-ACK bits are included in the HARQ-ACK codebook. The PDCCH MO carrying the last DCI is the last of the M MOs.

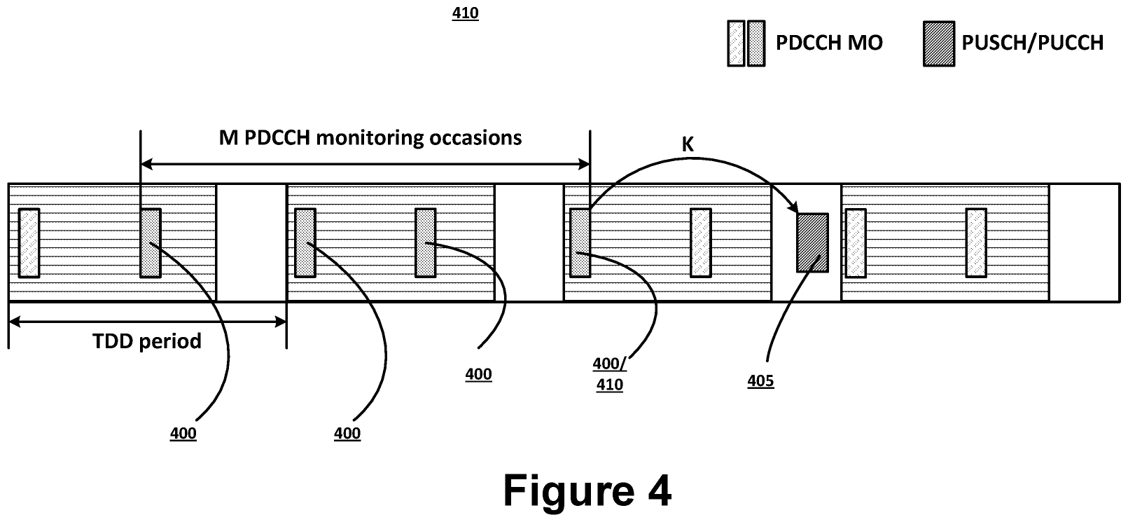

FIG. 4 illustrates an example to determine the configured PDCCH MOs relative to the last DCI. The above PDCCH MOs may include the M consecutive PDCCH MOs 400 that are not later than the PDCCH MO carrying the PDCCH scheduling the last DL data transmission. It will be understood that, because NR allows PDCCH and PDSCH transmissions in the same symbol in the same slot, in some embodiments the PDCCH MO may refer to a PDCCH and the scheduled PDSCH. Therefore, the PDSCH to HARQ-ACK feedback delay (i.e., K in FIG. 4) is shown with reference to the PDCCH MO. Additionally, it will be understood that, with respect to FIGS. 4-9, the PDCCH MOs that are solidly shaded grey (e.g., the PDCCH MOs marked 400 in FIG. 4) are within the M consecutive PDCCH MOs, while the PDCCH MOs that have diagonal shading (e.g., the unmarked PDCCH MOs) are not within the M PDCCH MOs.

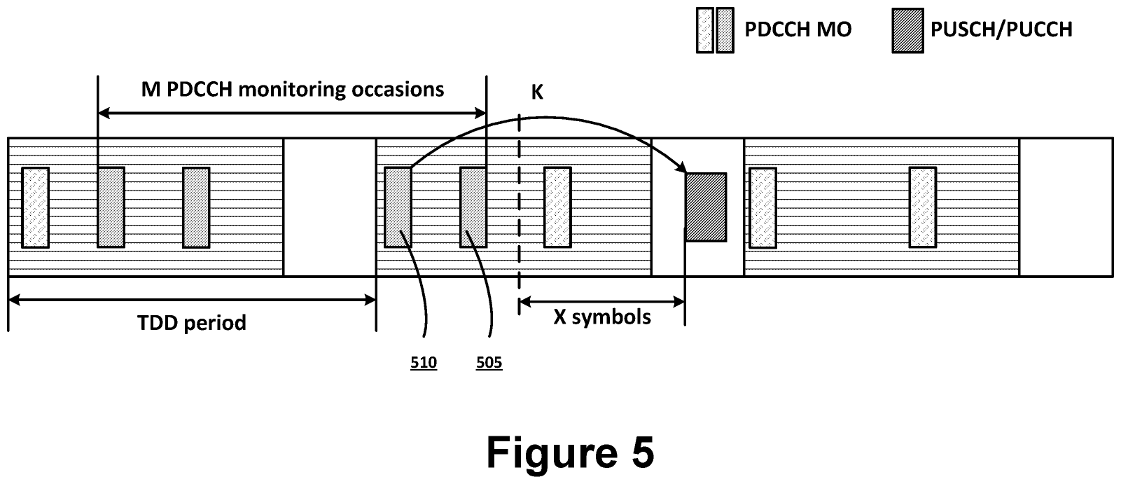

In one option, the M consecutive configured PDCCH MOs 400 are determined relative to the UL resource 405 (e.g., the PUSCH and/or PUCCH) that carries the HARQ-ACK information subjected to the necessary PDSCH processing time. The last of the M MOs 400 can be the last MO 410 that ends at least X symbols (as shown in FIG. 5) before the start symbol of the UL resource. X may depend, for example, on the UE PDSCH processing time. In other words, the last MO 410 may be based on a PDSCH to HARQ-ACK feedback delay “K” which refers (in FIGS. 4-9) to the delay between reception of the PDCCH 410 to transmission of the PUSCH/PUCCH at 405. In such case, indicating the value M or indicating a first MO may be used to determine the M consecutive configured MOs.

Alternatively as shown in FIG. 5, the last of the M MOs 510 may be earlier than the last MO 505 that ends at least X symbols before the start symbol of the UL resource. The first MO and the value M can be indicated by a starting and length indicator value (SLIV) in the last PDCCH that triggers HARQ-ACK transmission. Alternatively, the last MO and the value M can be indicated by a starting and length indicator value (SLIV) in the last PDCCH that triggers HARQ-ACK transmission.

FIG. 5 illustrates an example to determine the configured PDCCH MOs relative to the UL resource. The above PDCCH MOs consist of the M last consecutive PDCCH MOs that ends at least X symbols before the start symbol of the UL resource.

In one embodiment, the header may indicate whether each DCI in a dynamically determined set of DCIs that schedule DL data transmissions is received by the UE or not. The DCI in the set of DCIs may be ordered by a counter downlink assignment index (C-DAI) field in the DCI. The k^{th} DCI in the set of DCIs may indicate C-DAI equals to k, k=1, 2, . . . A modulo operation may be applied to C-DAI to reduce the size of C-DAI. The size M of the dynamically determined set of DCIs may be derived by the last DCI in the set. The header bitmap in the HARQ-ACK codebook may include M bits. The HARQ-ACK codebook may include HARQ-ACK bits corresponding to any received DCI in the set of DCIs.

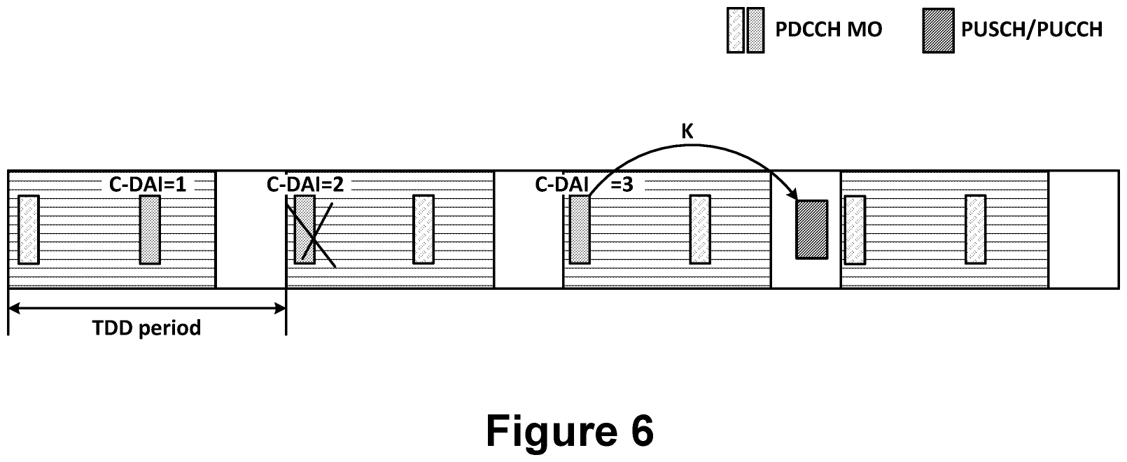

FIG. 6 illustrates an example for the dynamically determined set of DCIs for the HARQ-ACK codebook generation. According to the C-DAI in the last DCI that is used to derive the UL resource for HARQ-ACK transmission (i.e., C-DAI=3), the UE may be able to identify that the gNB transmits 3 DCIs that schedule DL data transmissions. Therefore, the header in the HARQ-ACK codebook may have 3 bits. Further, assuming the UE miss the second DCI (e.g., the DCI with a C-DAI=2 as shown in FIG. 6 as being crossed out), the UE may be able to identify the missing because the UE may receive the DCI with C-DAI=3. The header bitmap may be ‘1 0 1’. Finally, the UE may only include HARQ-ACK bits associated with the first DCI (e.g., the DCI with C-DAI=1) and the third DCI (e.g., the DCI with C-DAI=3) in the codebook. There may be padding bits so that the codebook size may be equal to the codebook size indicate by the last DCI.

In another embodiment, one PDCCH may be used to schedule a PUCCH or PUSCH transmission carrying HARQ-ACK feedback of one or more than one PDSCHs. In particular, the last DCI for scheduling PDSCHs may also include resource allocation in time and frequency for the PUCCH or PUSCH transmission carrying HARQ-ACK feedback.

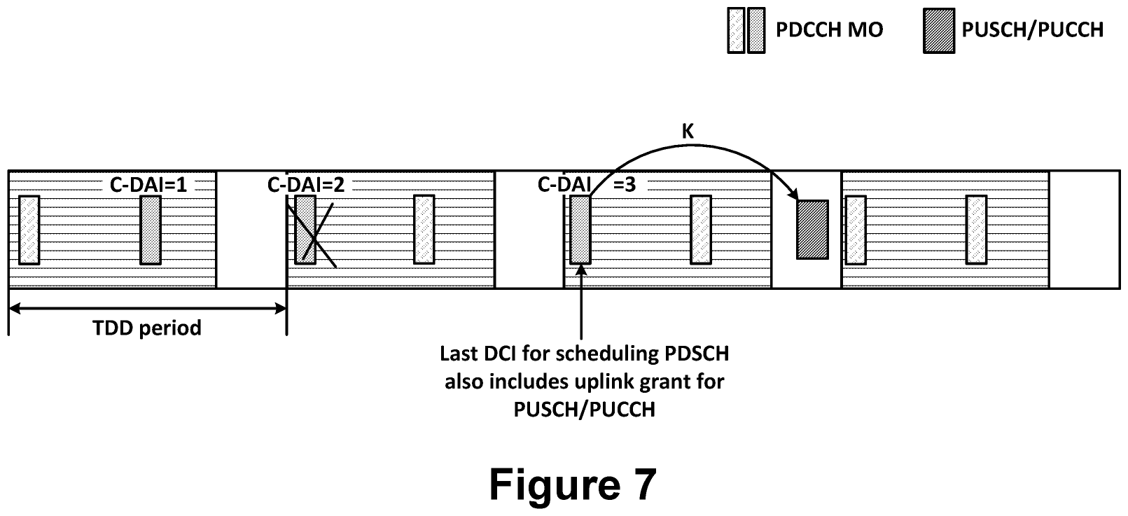

FIG. 7 illustrates an example of a last DCI including uplink grant for scheduling PUSCH/PUCCH. In the example, the last DCI (e.g., the DCI with C-DAI=3) used for scheduling PDSCHs may include the uplink grant for scheduling PUSCH or PUCCH, which carries HARQ-ACK feedback of three PDSCHs.

In another embodiment, depending on the processing time for PDSCH decoding and PUSCH/PUCCH transmission, or K1 and K2 values, respectively, a DCI which is transmitted after the last DCI for scheduling PDSCHs may be used to schedule PUCCH or PUSCH transmission carrying HARQ-ACK feedback.

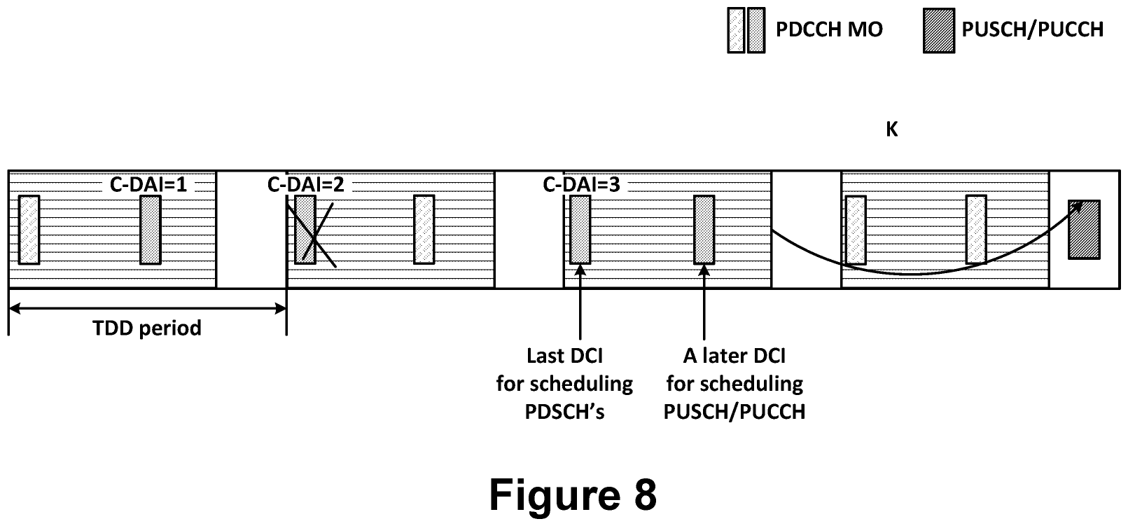

FIG. 8 illustrates one example of a later DCI that includes uplink grant for scheduling PUSCH/PUCCH. In the example, a DCI which is transmitted after the last DCI, includes the uplink grant for scheduling PUSCH or PUCCH, which carries HARQ-ACK feedback of three PDSCHs.

In another embodiment, more than one DCIs for scheduling a same PUCCH or PUSCH may be transmitted, which may help improve the reliability of the transmission of control information. Note that the more than one DCIs may include the last DCI scheduling PDSCHs or a DCI which is transmitted later than the last DCI. Alternatively, the more than one DCIs may include any DCI scheduling PDSCHs or a DCI which is transmitted later than the last DCI. The PUSCH or PUCCH may carry HARQ-ACK feedback of one or more than one PDSCHs.

Further, a same uplink resource allocation in time and frequency may be included in the more than one DCIs for scheduling the PUCCH or PUSCH. In addition, if M consecutive configured PDCCH MOs are used to determine the HARQ-ACK codebook, the more than one DCIs may include same set of M consecutive configured PDCCH MOs for HARQ-ACK codebook generation. Similarly, if a DAI offset is used to order the HARQ-ACK codebook generation, the DAI offset may need to point to the same set of DCIs for scheduling PDSCHs.

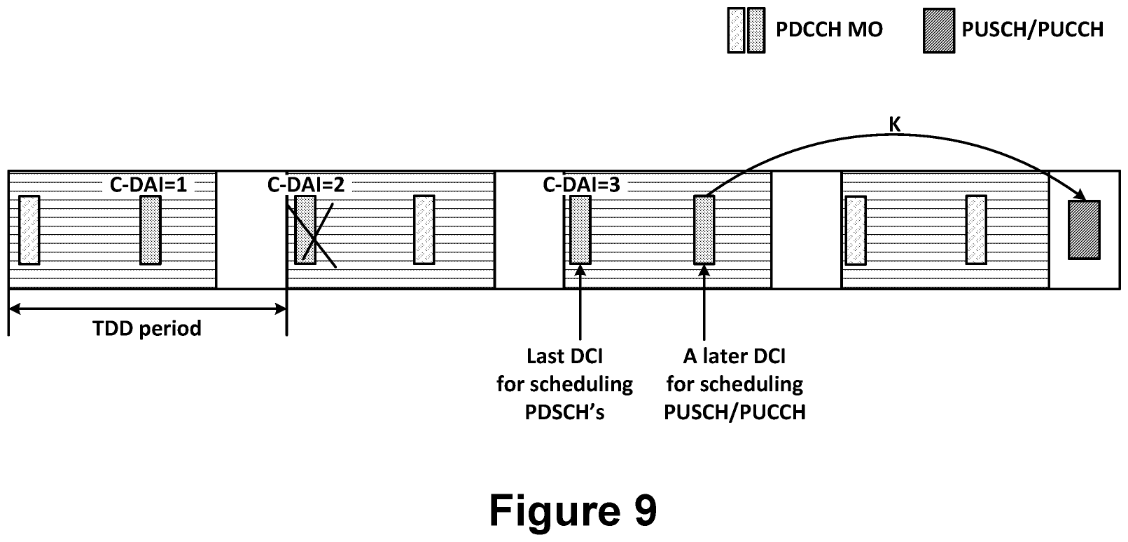

FIG. 9 illustrates one example of more than one DCIs including uplink grant for scheduling a same PUSCH/PUCCH. In the example, both last DCI and a DCI which is transmitted after the last DCI include the uplink grant for scheduling PUSCH or PUCCH, which carries HARQ-ACK feedback of three PDSCHs.

Downlink Control and HARQ-ACK Transmission for Multi-PDSCH Scheduling

Some embodiments herein may relate to downlink control and HARQ-ACK transmission for multi-PDSCH scheduling. Specifically, some embodiments may relate to mechanisms that allow long transmission duration and adequate processing time for higher layer or even scheduler implementation.

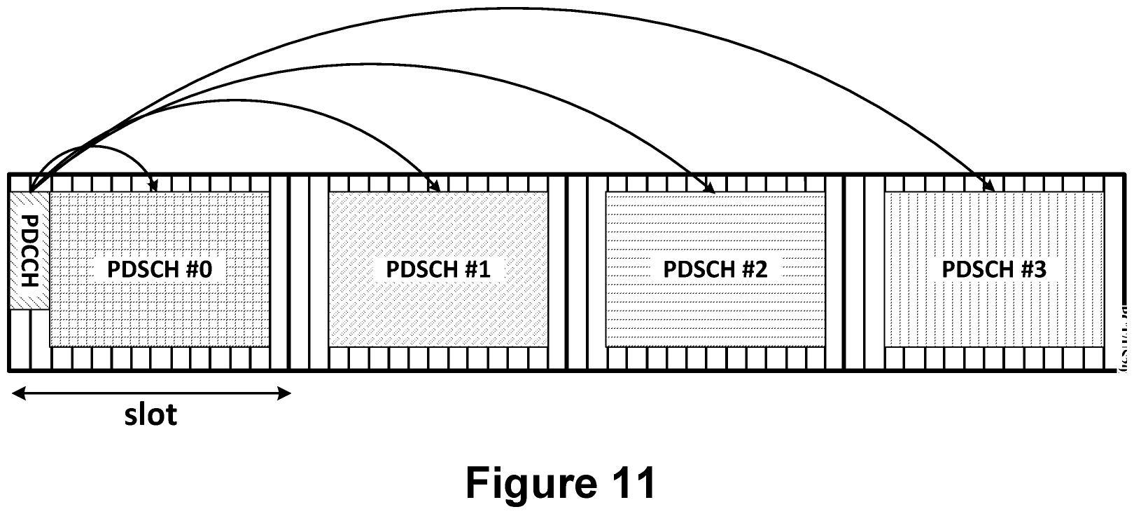

In some embodiments, a PDCCH transmission that carries DCI may be used to schedule one or more PDSCH transmissions with different TBs. FIG. 11 illustrates one example of multi-TTI scheduling for PDSCHs. In the example, 4 PDSCHs (PDSCH #0-3) with different transport blocks (TB) may be scheduled by a single DCI.

Among other things, embodiments herein relate to DCI design and corresponding HARQ-ACK transmission when multi-TTI scheduling for data transmission is considered in a system operating above an approximately 52.6 GHz carrier frequency.

A DCI that can schedule multiple PDSCH transmissions with different TBs is referred as a multi-PDSCH DCI. The number of scheduled PDSCHs by the DCI, denoted as N, may be explicitly indicated by a field in the DCI. Alternatively, the number of scheduled PDSCHs by the DCI may be jointly coded with other information field(s). For example, the number of scheduled PDSCHs for a row in a time domain resource allocation (TDRA) table may be equal to the number of configured SLIVs of the row. The maximum number of PDSCHs scheduled by a multi-PDSCH DCI may be the maximum number of scheduled PDSCHs among all rows, which is denoted as Nₘₐₓ.

In legacy NR design, the DAI may be 2 bits, which counts the number of PDCCHs for DL data scheduling. With 2 bits for the DAI, the UE may identify the missing PDCCHs if the number of consecutive missed PDCCH is no more than 3. Alternatively, because DAI may be a counter of PDCCHs, the same number of HARQ-ACK bits per PDCCH may be assumed in a HARQ-ACK codebook so that gNB and UE may identify the position of HARQ-ACK for a PDSCH that is scheduled by a PDCCH. In this way, if different PDSCHs are associated with different numbers of HARQ-ACK bits, the maximum number of HARQ-ACK bits among all PDSCHs is reported for each PDSCH.

For a DCI for multi-PDSCH scheduling, if DAI still counts PDCCH, the HARQ-ACK overhead may be increased. To reduce the HARQ-ACK codebook size, the DAI may count the number of scheduled PDSCHs or sets of scheduled PDSCHs. Consequently, the size of DAI may be more than 2 bits. The schemes to handle DAI field disclosed herein may apply to C-DAI only, or may apply to both the C-DAI and total DAI (T-DAI).

HARQ-ACK Codebook Generation

The Type2 HARQ-ACK codebook in NR may include two sub-codebooks. The first sub-codebook may include HARQ-ACK for all TB-based PDSCH transmissions. Herein, each PDSCH carries one TB, or two TBs if the number of spatial layers is more than 4. The second sub-codebook includes HARQ-ACK for all code block group (CBG)-based PDSCH transmissions. When at least one serving cell for the UE is configured with multi-PDSCH scheduling, the HARQ-ACK codebook may include two sub-codebooks.

In one embodiment, the first sub-codebook includes HARQ-ACK bits for TB based PDSCH transmissions scheduled by a single-PDSCH DCI. As used herein, a DCI that can only schedule a single PDSCH is referred as single-PDSCH DCI. The second sub-codebook includes HARQ-ACKs for other PDSCH transmissions. For example, the HARQ-ACK associated with the following cases could be included in the first sub-codebook:
Any DCI for a serving cell configured TB-based PDSCH transmission and single-PDSCH scheduling;
a fallback DCI on a serving cell configured with CBG-based transmission or multi-PDSCH scheduling;
a DCI triggering SPS PDSCH release;
a DCI indicating SCell dormancy.

In one embodiment, the first sub-codebook may include HARQ-ACK bits for TB based PDSCH transmissions scheduled by a DCI that schedules a single PDSCH. The second sub-codebook includes HARQ-ACKs for other PDSCH transmissions. For example, the HARQ-ACK associated with the following cases could be included in the first sub-codebook:
Any DCI for a serving cell configured TB-based PDSCH transmission and single-PDSCH scheduling;
a fallback DCI on a serving cell configured with CBG-based transmission or multi-PDSCH scheduling;
a multi-PDSCH DCI that schedules a single PDSCH;
a DCI triggering SPS PDSCH release;
a DCI indicating SCell dormancy.

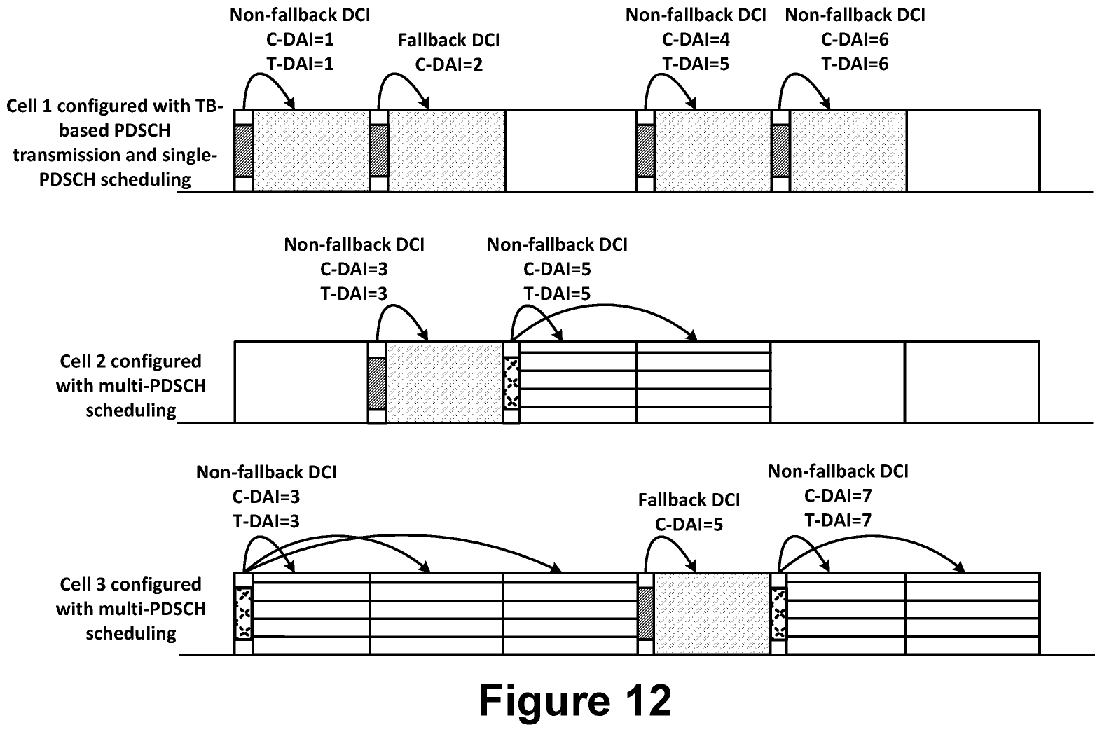

FIG. 12 illustrates one example for the generation of two sub-codebooks. 3 cells are configured for the UE in the example. Cell 1 is configured with TB-based transmission and single-PDSCH scheduling, while multi-PDSCH scheduling is configured for cell 2 and cell 3. Each PDSCH carries two TBs for cell 2. Each PDSCH carries single TB for cell 3. HARQ-ACK for the following cases are included in the first HARQ-ACK sub-codebook, which correspond to the diagonally-shaded blocks in FIG. 12:
All PDSCH transmissions on Cell 1;
PDSCH transmission scheduled by fallback DCI on cell 2 and cell 3;
Single PDSCH transmission on cell 2 and cell 3 that is scheduled by a multi-PDSCH DCI (e.g., non-fallback DCI).

On the other hand, HARQ-ACK for the following cases are included in the second HARQ-ACK sub-codebook, which correspond to the horizontally-shaded blocks in FIG. 3:
more than one PDSCH transmissions on cell 2 and cell 3 that are scheduled by a multi-PDSCH DCI.

In one embodiment, the first sub-codebook includes HARQ-ACK bits for TB based PDSCH transmissions scheduled by a DCI that schedules one or two TBs. The second sub-codebook includes HARQ-ACKs for other PDSCH transmissions. For example, the HARQ-ACK associated with the following cases could be included in the first sub-codebook:
Any DCI for a serving cell configured TB-based PDSCH transmission and single-PDSCH scheduling;
a fallback DCI on a serving cell configured with CBG-based transmission or multi-PDSCH scheduling;
a multi-PDSCH DCI that schedules two PDSCHs with no more than 4 layers or single PDSCH with more than 4 layers;
a DCI triggering SPS PDSCH release;
a DCI indicating SCell dormancy.

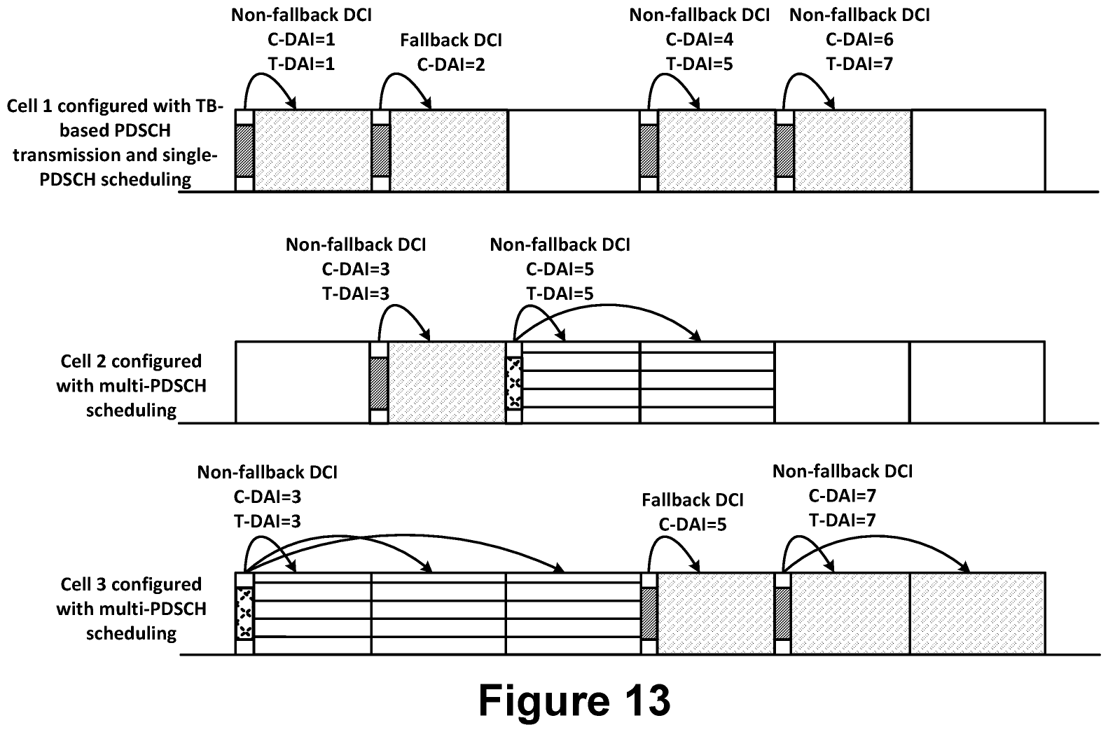

FIG. 13 illustrates one example for the generation of two sub-codebooks using the same CA assumption as FIG. 12. HARQ-ACK for the following cases are included in the first HARQ-ACK sub-codebook, which correspond to the diagonally-shaded blocks in 13:
All PDSCH transmissions on Cell 1;
PDSCH transmission scheduled by fallback DCI on cell 2 and cell 3;
Single PDSCH transmission on cell 2 that is scheduled by a multi-PDSCH DCI (e.g. non-fallback DCI);
One or two PDSCH transmissions on cell 3 that is scheduled by a multi-PDSCH DCI (e.g. non-fallback DCI).

On the other hand, HARQ-ACK for the following cases are included in the second HARQ-ACK sub-codebook, which correspond to the horizontally-shaded blocks in FIG. 13:
More than one PDSCH transmission on Cell 2 that are scheduled by a multi-PDSCH DCI;
More than two PDSCH transmissions on Cell 3 that are scheduled by a multi-PDSCH DCI.

In one embodiment, in the first sub-codebook, the number of HARQ-ACKs associated with a DCI is 1 or 2. The second sub-codebook includes HARQ-ACKs for other DCIs. For example, the HARQ-ACK associated with the following cases could be included in the first sub-codebook:
Any DCI for a serving cell configured TB-based PDSCH transmission and single-PDSCH scheduling;
a fallback DCI on a serving cell configured with CBG-based transmission or multi-PDSCH scheduling;
a multi-PDSCH DCI that schedules two PDSCHs with no more than 4 layers or single PDSCH with more than 4 layers;
a DCI that schedules PDSCH transmissions on a serving cell that is configured with two CBGs for a PDSCH
a DCI triggering SPS PDSCH release;
a DCI indicating SCell dormancy.

Size of DAI Field in DCI Format

The DAI field in a DCI may count the number of PDSCHs that are transmitted to the UE. The size of DAI field may be predefined, configured by high layer signaling, or determined by the maximum number of PDSCHs, denoted as Nₘₐₓ^{CA} that could be scheduled by a DCI among all serving cells. For example, to allow the possibility for UE to identify the missing of 3 consecutive PDCCHs, the size of DAI should be 2+┌log₂(Nₘₐₓ^{CA})┐. The number of HARQ-ACK bits per PDSCH can be determined by the maximum number of HARQ-ACKs per PDSCH that is associated with the codebook or sub-codebook among all serving cells.

Alternatively, the DAI field in a DCI may count the number of sets of PDSCHs that are transmitted to the UE. Denote number of sets of PDSCHs that is scheduled by a DCI as G, the number of PDSCHs in a set as g, for the N PDSCHs scheduled by a DCI, G=┌N/g┐. Each of first G−1 sets contains g PDSCHs. The remaining PDSCHs belong to the last set. Denote the maximum number of sets of PDSCHs that is scheduled by a DCI as Gₘₐₓ, Gₘₐₓ=┌Nₘₐₓ/g┐. In one example, two serving cells may be configured with same number of sets of PDSCHs while the number of PDSCHs per set is different. In another example, two serving cells may be configured with different number of sets of PDSCHs while the number of PDSCHs per set is same. The size of DAI field is predefined, configured by high layer signaling, or determined by the maximum number of sets of PDSCHs, denoted as Gₘₐₓ^{CA} that could be scheduled by a DCI among all serving cells. For example, to allow the possibility for UE to identify the missing of 3 consecutive PDCCHs, the size of DAI should be 2+┌log₂ (Gₘₐₓ^{CA})┐. The number of HARQ-ACK bits per set can be determined by the maximum number of HARQ-ACKs per set that is associated with the codebook or sub-codebook among all serving cells.

In one embodiment, the DCI format for all serving cells, irrespective of the configuration of multi-PDSCH scheduling or not, is configured with same size of DAI filed. For example, the size of DAI field is larger than 2 bits. Note: fallback DCI may still contain 2 bits for counter DAI (C-DAI). The DAI field in a DCI counts the number of PDSCHs that are transmitted to the UE. Alternatively, the DAI field in a DCI counts the number of sets of PDSCHs that are transmitted to the UE.

In one option, the HARQ-ACK codebook may include two sub-codebooks. The first sub-codebook includes HARQ-ACK bits for TB based PDSCH transmissions scheduled by a single-PDSCH DCI, by a DCI that schedules single PDSCH, or by a DCI that schedules one or two TBs. Alternatively, in the first sub-codebook, the number of HARQ-ACK bits associated with a DCI is 1 or 2. The second sub-codebook includes HARQ-ACKs for other PDSCH transmissions or DCIs.

In another option, the HARQ-ACK codebook is generated by ordering the HARQ-ACK bits for the PDSCHs on all serving cells. If the DAI counts the number of PDSCHs, the number of HARQ-ACK bits associated with a PDSCH is determined by the maximum number of configured HARQ-ACK bits per PDSCH among all serving cells. If the DAI counts the number of sets of PDSCHs, the number of HARQ-ACK bits associated with a set is determined by the maximum number of configured HARQ-ACK bits per set among all serving cells. For the PDSCH scheduled by a single-PDSCH DCI, it is mapped to a set with single PDSCH.

In one embodiment, the size of DAI field in a DCI is fixed for a serving cell. For a first cell configured with TB-based PDSCH transmission and single-PDSCH scheduling, the DAI filed has a size of sizeA, e.g. sizeA equals to 2. The DAI field in a DCI may still count the number of PDCCHs. For a second cell configured with CBG-based PDSCH transmission or multi-PDSCH scheduling, the DAI filed has a size of sizeB, e.g. sizeB can be larger than 2. Note: fallback DCI may still contain 2 bits for C-DAI. The DAI field in a DCI counts the number of PDSCHs that are transmitted to the UE. Alternatively, the DAI field in a DCI counts the number of sets of PDSCHs that are transmitted to the UE.

The HARQ-ACK codebook can include two sub-codebooks. The first sub-codebook includes HARQ-ACK bits for TB based PDSCH transmissions scheduled by a single-PDSCH DCI, by a DCI that schedules single PDSCH, or by a DCI that schedules one or two TBs. For the PDSCH transmission(s) on the second cell that is scheduled by a multi-PDSCH DCI, if the associated HARQ-ACK for the DCI is included in the first sub-codebook, the DAI in the DCI counts the number of PDCCHs that associates with the first sub-codebook. By this way, all DCIS that are associated with the first sub-codebook have common definition of DAI. On the other hand, If the associated HARQ-ACK for the DCI is included in the second sub-codebook, the DAI in the associated DCI counts the number of PDSCHs or sets of PDSCHs for the second sub-codebook.

In one embodiment, assuming the HARQ-ACK codebook include two sub-codebooks, the DAI field in a DCI format could have same size for all DCIS that are associated with the same sub-codebook. The first sub-codebook includes HARQ-ACK bits for TB based PDSCH transmissions scheduled by a single-PDSCH DCI, by a DCI that schedules single PDSCH, or by a DCI that schedules one or two TBs. Alternatively, in the first sub-codebook, the number of HARQ-ACK bits associated with a DCI is 1 or 2. The second sub-codebook includes HARQ-ACKs for other PDSCH transmissions or DCIS.

The size of DAI in a DCI is sizeA bits for the first sub-codebook, e.g. sizeA equals to 2. The DAI in a DCI for the first sub-codebook may still count the number of PDCCHs. On the other hand, the size of DAI in a DCI is sizeB bits for the second sub-codebook, e.g. sizeB can be larger than 2. The DAI in a DCI for the second sub-codebook counts the number of PDSCHs or sets of PDSCHs. Note: fallback DCI may still contain 2 bits for C-DAI.

In one option, for the second sub-codebook, the size of DAI field can be determined by the maximum number of PDSCHs. In another option, for the second sub-codebook, the size of DAI field is determined by the maximum number of sets of PDSCHs.

The size of DAI field in a multi-PDSCH DCI can be determined by the sub-codebook that is used to transmit the HARQ-ACKs associated with the DCI. If the HARQ-ACK for the PDSCH transmission scheduled by the DCI is included in the first sub-codebook, the DAI field in the DCI has sizeA. On the other hand, if the HARQ-ACK bits for the PDSCH transmissions scheduled by the DCI is included in the second sub-codebook, the size of DAI field in the DCI has sizeB.

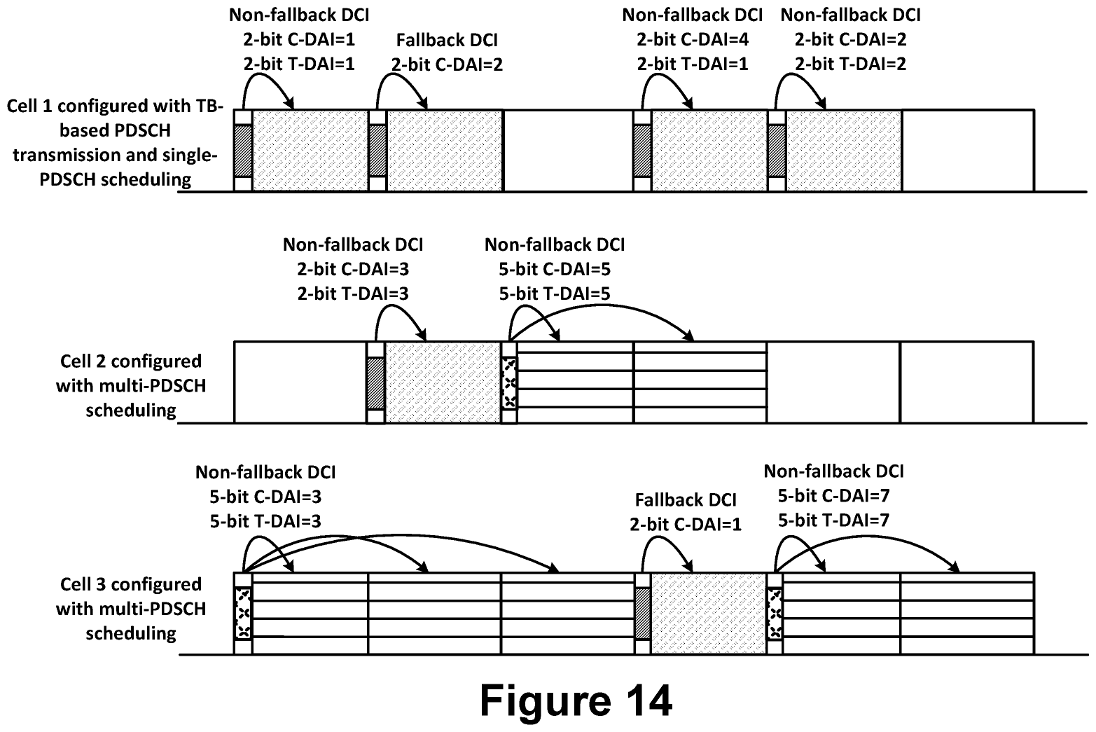

FIG. 14 illustrates one example for the size of DAI field in the DCIS using the same CA assumption as FIG. 12. The size of DAI field in a DCI is 2 for the following cases, which corresponds to the solid dark shaded PDCCHs in FIG. 14:
all DCI on Cell 1;
fallback DCI on cell 2 and cell 3;
A multi-PDSCH DCI that schedules single PDSCH transmission on cell 2 and cell 3.

On the other hand, assuming DAI counts the number of PDSCH transmission and assuming a multi-PDSCH DCI can schedule up to 8 PDSCHs, the size of DAI field in the DCI is for the following cases, which corresponds to the PDCCHs with black grid:
A multi-PDSCH DCI that schedules more than one PDSCH transmissions on cell 2 and cell 3.

Size of DCI Format for Multi-PDSCH Scheduling

The HARQ-ACK codebook can include two sub-codebooks. The size of DAI in a DCI is sizeA bits for the first sub-codebook, e.g. sizeA equals to 2. On the other hand, the size of DAI in a DCI is sizeB bits for the second sub-codebook, e.g. sizeB can be larger than 2.

In one option, assuming the first sub-codebook includes HARQ-ACK bits for TB based PDSCH transmissions scheduled by a DCI that schedules single PDSCH, the size of a multi-PDSCH DCI is determined by the maximum of the DCI size when single PDSCH is scheduled by the DCI and the DCI size when the maximum number of PDSCHs are scheduled by the DCI.

In another option, assuming the first sub-codebook includes HARQ-ACK bits for TB based PDSCH transmissions scheduled by a DCI that schedules one or two TBs, the size of a multi-PDSCH DCI is determined by the maximum of the DCI size when one or two PDSCHs are scheduled by the DCI and the DCI size when the maximum number of PDSCHs are scheduled by the DCI. For the serving cell configured with multi-PDSCH scheduling, it is assumed that each PDSCH carries only one TB.

### Example Procedure

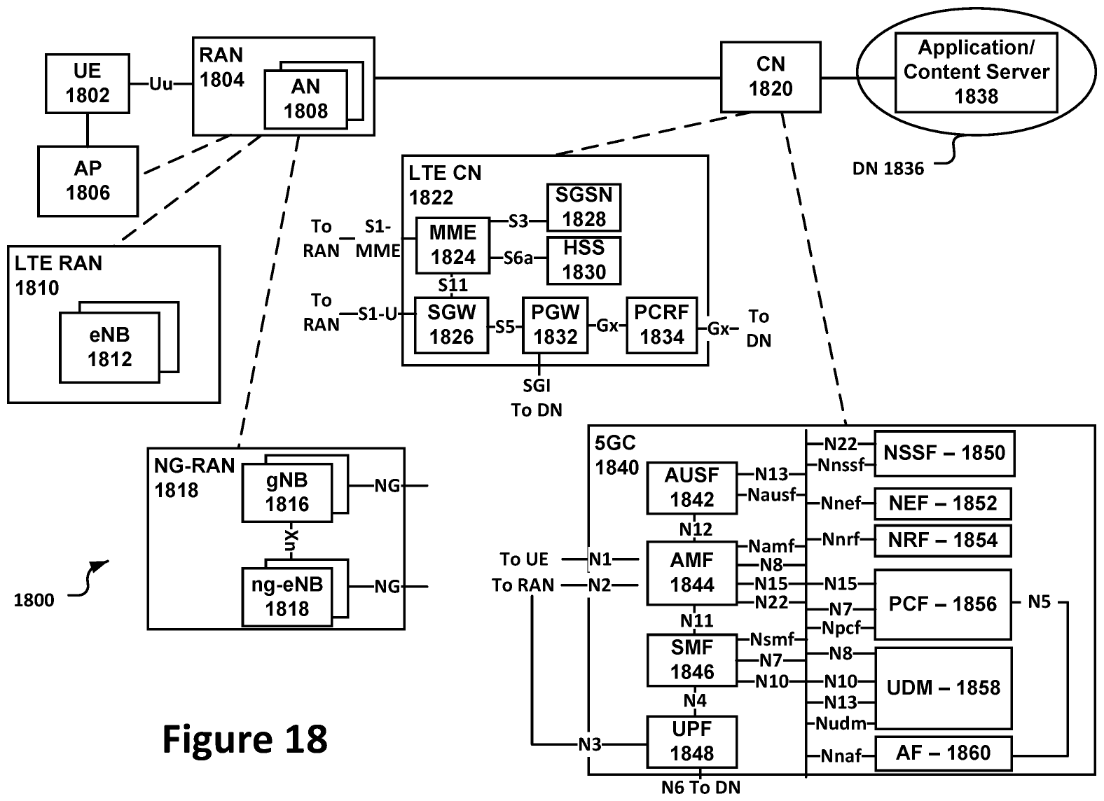

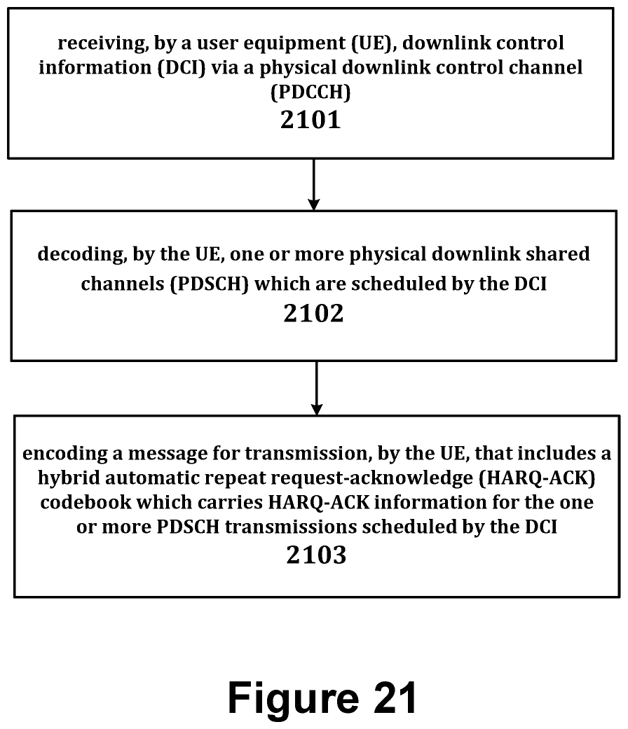

In some embodiments, the electronic device(s), network(s), system(s), chip(s) or component(s), or portions or implementations thereof, of FIGS. 18-20 described herein, or some other figure herein, may be configured to perform one or more processes, techniques, or methods as described herein, or portions thereof. One such process is depicted in FIG. 21. For example, the process may include, at 2101, receiving, by a user equipment (UE), downlink control information (DCI) via a physical downlink control channel (PDCCH). The process further includes, at 2102, decoding, by the UE, one or more physical downlink shared channels (PDSCH) which are scheduled by the DCI. The process further includes, at 2103, encoding a message for transmission, by the UE, that includes a hybrid automatic repeat request-acknowledgement (HARQ-ACK) codebook which carries HARQ-ACK information for the one or more PDSCH transmissions scheduled by the DCI.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

HARQ-ACK Codebook Size Determination for Multi-PDSCH Scheduling

Some embodiments may relate to HARQ-ACK codebook size determination for multi-PDSCH scheduling. Specifically, some embodiments may relate to mechanisms that allow long transmission duration and adequate processing time for higher layer or even scheduler implementation.

As previously noted (for example, with respect to FIG. 11), a PDCCH transmission carrying DCI information may be used to schedule one or more PDSCH transmissions with different TBs. As noted, FIG. 11 illustrates one example of multi-TTI scheduling for PDSCHs. In the example, 4 PDSCHs (PDSCH #0-3) with different transport blocks (TB) are scheduled by a single DCI.

Among other things, embodiments of the present disclosure are directed to DCI design and corresponding HARQ-ACK transmission when multi-TTI scheduling for data transmission is considered in system operating above 52.6 GHz carrier frequency.

As used herein, a DCI that can schedule multiple PDSCH transmissions with different TBs is referred as a multi-PDSCH DCI. A DCI that can only schedule a single PDSCH is referred as single-PDSCH DCI. The HARQ-ACK codebook may include two sub-codebooks. The first sub-codebook includes HARQ-ACK bits for TB based PDSCH transmissions scheduled by a single-PDSCH DCI, by a DCI that schedules single PDSCH, or by a DCI that schedules one or two TBs.

Alternatively, in the first sub-codebook, the number of HARQ-ACK bits associated with a DCI is 1 or 2. The second sub-codebook includes HARQ-ACKs for other PDSCH transmissions or DCIs.

For a DCI for multi-PDSCH scheduling, to reduce the HARQ-ACK codebook size, the C-DAI may count the number of scheduled PDSCHs or sets of scheduled PDSCHs. Consequently, the size of C-DAI can be more than 2 bits.

Handling C-DAI and T-DAI

In NR HARQ-ACK transmission, the C-DAI may count the number of PDCCHs that are used to order the HARQ-ACK bits in the codebook. In addition, the T-DAI may be used to determine the codebook size for the HARQ-ACK transmission.

In one embodiment, C-DAI and T-DAI may have the same size in a DCI that schedules PDSCH transmission(s) on a serving cell.

In one option, if C-DAI counts the number of PDSCHs or sets of PDSCHs on all serving cells, the T-DAI indicates the total number of PDSCHs or sets of PDSCHs that are scheduled by the gNB. For example, if up to 8 PDSCHs can be scheduled by a DCI, both C-DAI and T-DAI can be increased to 5 bits.

In another option, if C-DAI counts the number of PDSCHs or sets of PDSCHs that are associated with a sub-codebook, the T-DAI indicates the total number of PDSCHs or sets of PDSCHs by the gNB that are associated with same sub-codebook. For example, if up to 8 PDSCHs can be scheduled by a DCI, each set of PDSCHs can contain up to 4 PDSCHs, both C-DAI and T-DAI can be increased to 3 bits.

In one embodiment, T-DAI may directly indicates the exact size of HARQ-ACK payload. For example, assuming the maximum HARQ-ACK payload size is configured as X, with T bits for T-DAI, the indicatable HARQ-ACK payload size can be X·t/2^{T}, t=1,2,3, . . . 2^{T}. C-DAI and T-DAI may have same or different size in a DCI that schedules PDSCH transmission on a serving cell. The C-DAI may count the number of PDCCHs, or the number of sets of PDSCHs. The HARQ-ACK bits can be ordered by C-DAI so that a sequence of HARQ-ACK bits can be generated. If the length of the sequence of HARQ-ACK bits generated by the C-DAI is less than the HARQ-ACK payload size indicated by the T-DAI, padding bits are added until the length equals to the payload size indicated by T-DAI. An example is shown 15.

In one embodiment, T-DAI indicates the quantized HARQ-ACK payload size based on the length of the sequence of HARQ-ACK bits that is generated by the C-DAI. C-DAI and T-DAI may the different size in a DCI that schedules PDSCH transmission on a serving cell. The C-DAI may count the number of PDCCHs, or the number of sets of PDSCHs. The HARQ-ACK bits can be ordered by C-DAI so that a sequence of HARQ-ACK bits can be generated. Denoted the length of HARQ-ACK sequence as L, the size of T-DAI as T.

To be able to identify missing up to X consecutive PDCCHs, denote the maximum number of HARQ-ACK bits that is associated with a PDCCH as D, the T-DAI value could be determined based on mod(L,Y),Y=D·(X+1). T-DAI can indicate 2^{T} values in range [0, Y−1], e.g. T=2. For example, the values are Y·t/2^{T}, t=0,1, . . . 2^{T}−1. T-DAI in the last DCI is set to a lowest T-DAI value Q that is larger than or equal to mod(L,Y). The HARQ-ACK codebook size is Y·└L/Y┘+Q. Assuming UE can miss up to X last PDCCHs, the length of HARQ-ACK sequence generated by C-DAI at UE side must be larger than Y·└L/Y┘−Y+Q, therefore, UE can determine the correct HARQ-ACK codebook size as Y·└L/Y┘+Q since T-DAI indicates value Q.

In one option, if C-DAI counts the number of PDSCHs, denote the size of C-DAI as C, the maximum number of HARQ bits per PDSCH as M, the T-DAI value could be determined based on mod (L,Y), Y=2^{C}·M. T-DAI can indicate 2^{T} values in range [0, 2^{C}·M−1], e.g. T=2. For example, the values are 2^{C-T}·M·t, t=0,1, . . . 2^{T}−1. T-DAI in the last DCI is set to a lowest T-DAI value Q that is larger than or equal to mod(L, 2^{C}·M). The HARQ-ACK codebook size is 2^{C}·M·└L/(2^{C}·M)┘+Q.

In another option, if C-DAI counts the number of sets of PDSCHs, denote the size of C-DAI as C, the maximum number of HARQ bits per set as G, the T-DAI value could be determined based on mod (L,Y), Y=2^{C}·G. T-DAI can indicate 2^{T} values in range [0, 2^{C}·G−1], e.g. T=2. For example, the values are 2^{C-T}·G·t, t=0,1, . . . 2^{T}−1. T-DAI in the last DCI is set to a lowest T-DAI value Q that is larger than or equal to mod (L, 2^{C}·G). The HARQ-ACK codebook size is 2^{C}·G·└L/(2^{C}·G)┘+Q.

If C-DAI in a DCI counts the number of PDCCHs, the T-DAI in the same DCI counts total number of DCIS that are transmitted by gNB. For example, if the HARQ-ACK codebook includes two sub-codebooks, the C-DAI and T-DAI in a DCI that is associated with the first sub-codebook counts the number of PDCCHs. The size of C-DAI and T-DAI for the first sub-codebook can be 2 bits. On the other hand, for the second sub-codebook, the C-DAI counts the number of PDSCHs or sets of PDSCHs, while the T-DAI indicates the quantized HARQ-ACK payload size based on the length of the sequence of HARQ-ACK bits of the second sub-codebook that is generated by the C-DAI. The size of C-DAI for the second sub-codebook can be more than 2 bits, while the size of T-DAI for the second sub-codebook can be still 2 bits.

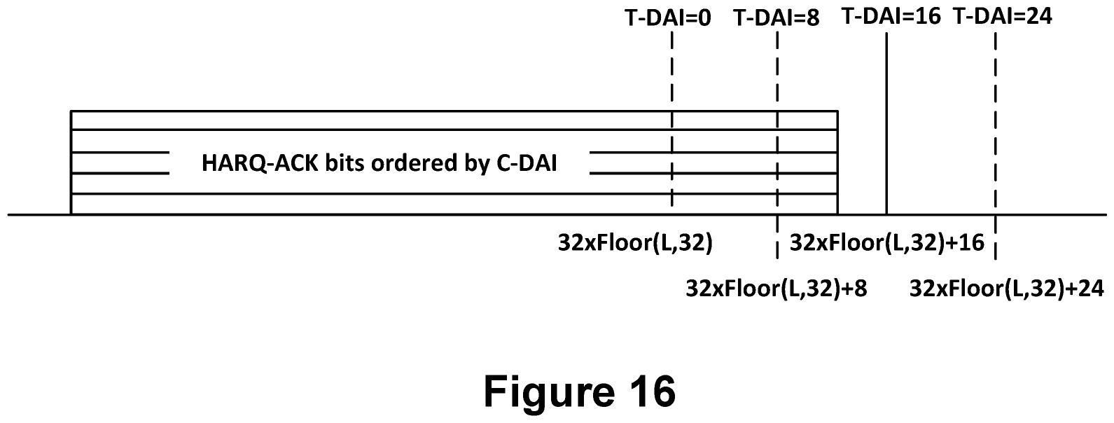

FIG. 16 illustrates one example to interpret T-DAI field. It is assumed that each multi-PDSCH DCI can schedule up to 8 PDSCH, one HARQ-ACK bit needs to be reported for each PDSCH, C-DAI counts the number of scheduled PDSCHs using 5 bits, and T-DAI uses 2 bits. Since the number of HARQ-ACK bits for PDSCH transmissions scheduled by 4 PDCCHs can be up to 32 bits, T-DAI can be one value from [0, 8, 16, 24]. Assuming the number of HARQ-ACK bits is L which is determined by C-DAI, T-DAI in the last DCI is set to a lowest value that is larger than or equal to mod(L, 32), which is denoted as Q. The HARQ-ACK payload size is 32·└L/32┘+Q. In FIG. 4, T-DAI is set to 16 which indicates a quantized payload size of 32·└L/32┘+16. At UE side, assuming UE can miss up to 3 last PDCCHs, the length of HARQ-ACK sequence generated by C-DAI at UE side must be larger than 32·└L/32┘−32+16, therefore, UE can determine the correct HARQ-ACK codebook size as 32·└L/32┘+Q since T-DAI indicate value Q.

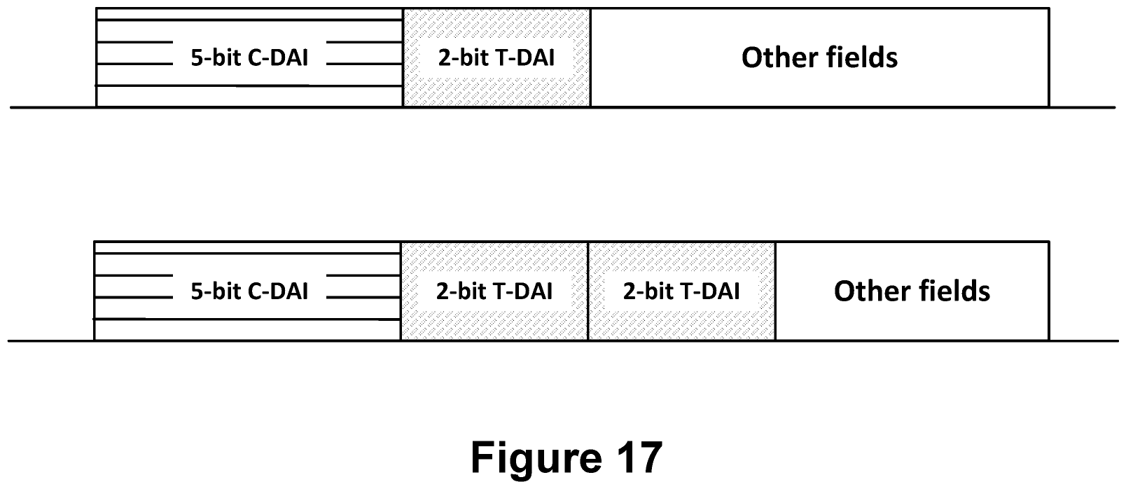

FIG. 17 illustrates one example for the size of C-DAI and T-DAI field in a multi-PDSCH DCI. It is assumed that each multi-PDSCH DCI can schedule up to 8 PDSCH, the C-DAI counts the number of scheduled PDSCHs using 5 bits, while T-DAI uses 2 bits. A multi-PDSCH DCI includes a 5-bit C-DAI field and a 2-bit T-DAI field. Further, assuming two PDSCH groups for HARQ-ACK transmission are used as defined in Rel-16 NR-U and T-DAI for both PDSCH groups are configured in the DCI, a multi-PDSCH DCI includes a 5-bit C-DAI field and two T-DAI fields of 2 bits.

DAI in UL Grant

In NR, a DAI field in the UL grant may be used to determine the size of HARQ-ACK codebook size when HARQ-ACK is transmitted on PUSCH. The UL grant may include one, two or four DAIs according to the configuration of HARQ-ACK sub-codebooks and the PDSCH groups for HARQ-ACK transmission are used as defined in Rel-16 NR-U.

In one option, if C-DAI in a DL assignment counts the number of PDSCHs or sets of PDSCHs on all serving cells, the DAI in UL grant indicates the total number of PDSCHs or sets of PDSCHs that are scheduled by the gNB. For example, assuming up to 8 PDSCHs can be scheduled by a DCI and DAI counts the number of PDSCH, the size C-DAI can be 5 bits. Correspondingly, a DAI in UL grant has 5 bits too. If there exists X DAIs in UL grant, the overhead of DAI is 2N bits.

In another option, if C-DAI in a DL assignment counts the number of PDSCHs or sets of PDSCHs that are associated with a sub-codebook, the DAI in UL grant indicates the total number of PDSCHs or sets of PDSCHs by the gNB that are associated with same sub-codebook. For example, assuming T-DAI for the first sub-codebook is still 2 bits to count number of PDCCHs, and T-DAI in the second sub-codebook is 5 bits to count number of PDSCHs, the sizes of DAIs in UL grant are 2 and 5 for the first and second sub-codebook respectively. Consequently, the overhead of two DAIs in UL grant has 2+5=7 bits. If two PDSCH groups as in NR-U applies, the overhead of four DAIs in UL grant has 2+5+2+5=14 bits.

In another option, the DAI in UL grant indicates the quantized HARQ-ACK payload size based on the length of the sequence of HARQ-ACK bits that is generated by the C-DAI. For example, when the size of C-DAI in DL grant is more than 2 bits, a DAI of 2 bits in UL grant can indicate one from four quantized payload size. If there exists X DAIs in UL grant, the overhead of DAI is 2N bits.

In another option, a DAI field in UL grant that is associated with a sub-codebook has the same size as a T-DAI field in DL assignment for the same sub-codebook. For example, when the size of C-DAI in DL grant is more than 2 bits, the size of T-DAI in DL assignment and the DAI in UL grant can be 2 bits.

Presence of T-DAI in a DL Assignment

In NR, if UE is configured with single serving cell, there exists only C-DAI in a DCI, however, there is no T-DAI in the DCI. In fact, for single serving cell, T-DAI always has the same value as C-DAI. Therefore, T-DAI is not necessary. For a HARQ-ACK codebook including two sub-codebooks, the presence of T-DAI may be handled differently.

In one option, for CA operation, if there is only one serving cell that is configured with TB-based transmission and single-PDSCH scheduling, T-DAI is not present in a DCI that is associated with the first sub-codebook. Further, if there is only one serving cell that is configured with CBG-based transmission and/or multi-PDSCH scheduling, T-DAI is not present in a DCI that is associated with the second sub-codebook.

In another option, for CA operation, if there is only one serving cell that is configured with TB-based transmission and single-PDSCH scheduling, T-DAI is not present in a DCI that is associated with the serving cell. Further, if there is only one serving cell that is configured with CBG-based transmission and/or multi-PDSCH scheduling, T-DAI is not present in a DCI that is associated with the serving cell.

In another option, for CA operation, if there is only one serving cell that is configured with TB-based transmission and single-PDSCH scheduling, and if the first sub-codebook doesn't include the HARQ-ACK bits that are associated with a non-fallback DCI that schedules PDSCH transmissions on a serving cell configured with CBG-based transmission and/or multi-PDSCH scheduling, T-DAI is not present in a DCI that is associated with the first sub-codebook. Further, if there is only one serving cell configured with CBG-based transmission and/or multi-PDSCH scheduling, T-DAI is not present in a DCI that is associated with the second sub-codebook.

### Example Procedure

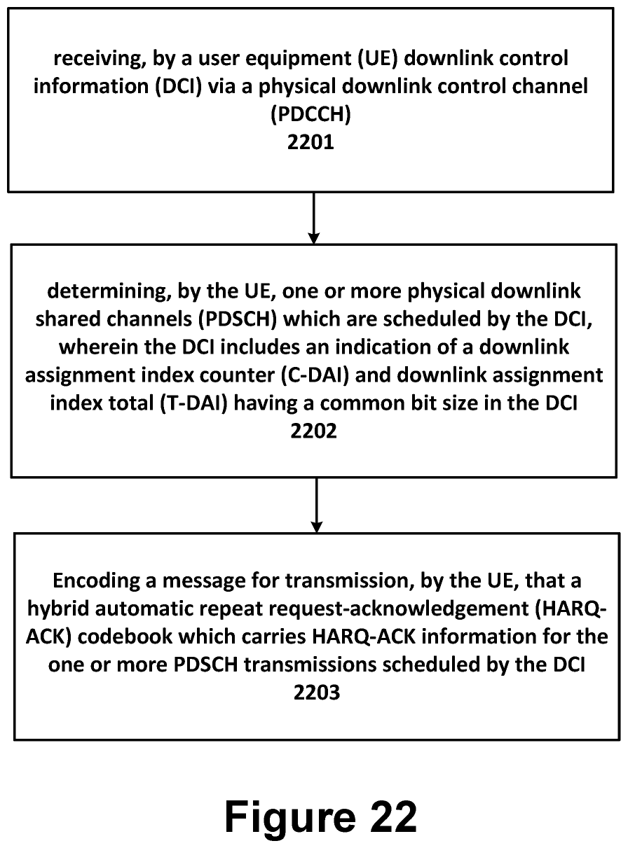

In some embodiments, the electronic device(s), network(s), system(s), chip(s) or component(s), or portions or implementations thereof, of FIGS. 18-20, or some other figure herein, may be configured to perform one or more processes, techniques, or methods as described herein, or portions thereof. One such process is depicted in FIG. 22. For example, the process may include, at 2201, receiving, by a user equipment (UE) downlink control information (DCI) via a physical downlink control channel (PDCCH). The process further includes, at 2202, determining, by the UE, one or more physical downlink shared channels (PDSCH) which are scheduled by the DCI, wherein the DCI includes an indication of a downlink assignment index counter (C-DAI) and downlink assignment index total (T-DAI) having a common bit size in the DCI. The process further includes, at 2203, encoding a message for transmission, by the UE, that a hybrid automatic repeat request-acknowledgement (HARQ-ACK) codebook which carries HARQ-ACK information for the one or more PDSCH transmissions scheduled by the DCI.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### Additional Example Procedures

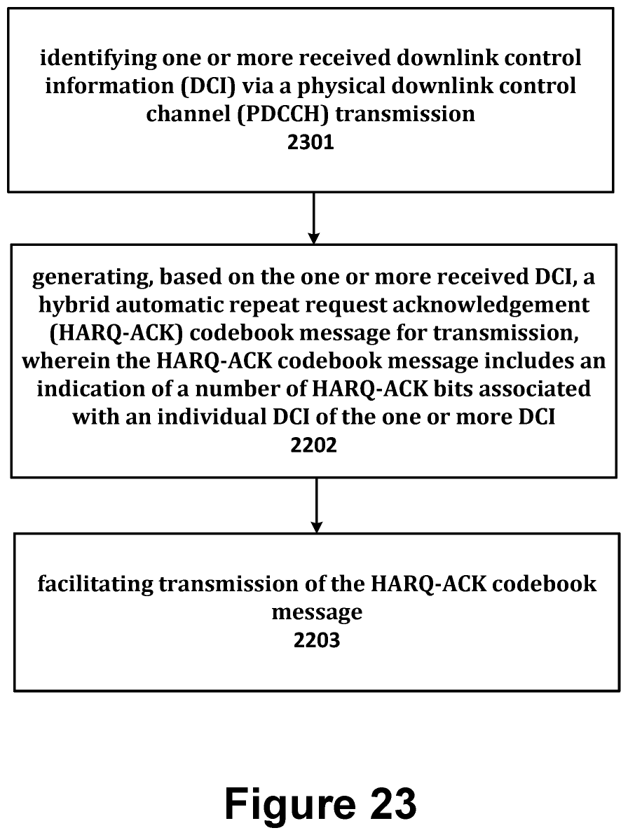

In some embodiments, the electronic device(s), network(s), system(s), chip(s) or component(s), or portions or implementations thereof, of FIGS. 18-20, or some other FIG. herein, may be configured to perform one or more processes, techniques, or methods as described herein, or portions thereof. One such process is depicted in FIG. 23. The process of FIG. 23 may be performed by an electronic device associated with a user equipment (UE) of a cellular network. The process may include: identifying, at 2301, one or more received downlink control information (DCI) via a physical downlink control channel (PDCCH) transmission; generating, at 2302 based on the one or more received DCI, a hybrid automatic repeat request acknowledgement (HARQ-ACK) codebook message for transmission, wherein the HARQ-ACK codebook message includes an indication of a number of HARQ-ACK bits associated with an individual DCI of the one or more DCI; and facilitating, at 2303, transmission of the HARQ-ACK codebook message.

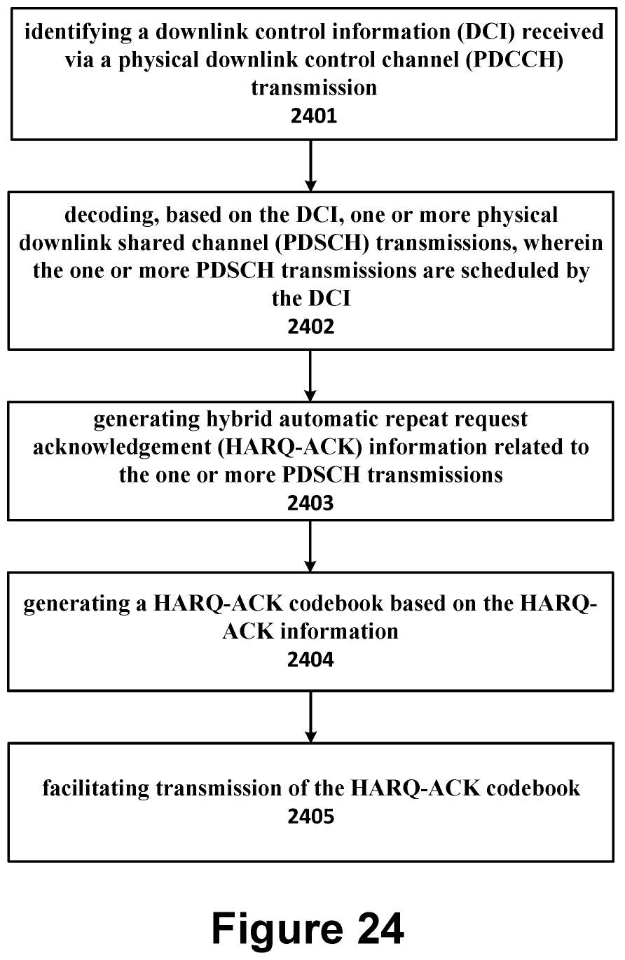

Another such process is depicted in FIG. 24. The process of FIG. 24 may likewise be performed by an electronic device associated with a UE of a cellular network. The process may include: identifying, at 2401, a downlink control information (DCI) received via a physical downlink control channel (PDCCH) transmission; decoding, at 2402 based on the DCI, one or more physical downlink shared channel (PDSCH) transmissions, wherein the one or more PDSCH transmissions are scheduled by the DCI; generating, at 2403, hybrid automatic repeat request acknowledgement (HARQ-ACK) information related to the one or more PDSCH transmissions; generating, at 2404, a HARQ-ACK codebook based on the HARQ-ACK information; and facilitating, at 2405, transmission of the HARQ-ACK codebook.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### Systems and Implementations

FIGS. 18-20 illustrate various systems, devices, and components that may implement aspects of disclosed embodiments.

FIG. 18 illustrates a network 1800 in accordance with various embodiments. The network 1800 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 1800 may include a UE 1802, which may include any mobile or non-mobile computing device designed to communicate with a RAN 1804 via an over-the-air connection. The UE 1802 may be communicatively coupled with the RAN 1804 by a Uu interface. The UE 1802 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 1800 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 1802 may additionally communicate with an AP 1806 via an over-the-air connection. The AP 1806 may manage a WLAN connection, which may serve to offload some/all network traffic from the RAN 1804. The connection between the UE 1802 and the AP 1806 may be consistent with any IEEE 802.11 protocol, wherein the AP 1806 could be a wireless fidelity (Wi-Fi®) router. In some embodiments, the UE 1802, RAN 1804, and AP 1806 may utilize cellular-WLAN aggregation (for example, LWA/LWIP). Cellular-WLAN aggregation may involve the UE 1802 being configured by the RAN 1804 to utilize both cellular radio resources and WLAN resources.

The RAN 1804 may include one or more access nodes, for example, AN 1808. AN 1808 may terminate air-interface protocols for the UE 1802 by providing access stratum protocols including RRC, PDCP, RLC, MAC, and L1 protocols. In this manner, the AN 1808 may enable data/voice connectivity between CN 1820 and the UE 1802. In some embodiments, the AN 1808 may be implemented in a discrete device or as one or more software entities running on server computers as part of, for example, a virtual network, which may be referred to as a CRAN or virtual baseband unit pool. The AN 1808 be referred to as a BS, gNB, RAN node, eNB, ng-eNB, NodeB, RSU, TRxP, TRP, etc. The AN 1808 may be a macrocell base station or a low power base station for providing femtocells, picocells or other like cells having smaller coverage areas, smaller user capacity, or higher bandwidth compared to macrocells.

In embodiments in which the RAN 1804 includes a plurality of ANs, they may be coupled with one another via an X2 interface (if the RAN 1804 is an LTE RAN) or an Xn interface (if the RAN 1804 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 1804 may each manage one or more cells, cell groups, component carriers, etc. to provide the UE 1802 with an air interface for network access. The UE 1802 may be simultaneously connected with a plurality of cells provided by the same or different ANs of the RAN 1804. For example, the UE 1802 and RAN 1804 may use carrier aggregation to allow the UE 1802 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 1804 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 1802 or AN 1808 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 1804 may be an LTE RAN 1810 with eNBs, for example, eNB 1812. The LTE RAN 1810 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 1804 may be an NG-RAN 1814 with gNBs, for example, gNB 1816, or ng-eNBs, for example, ng-eNB 1818. The gNB 1816 may connect with 5G-enabled UEs using a 5G NR interface. The gNB 1816 may connect with a 5G core through an NG interface, which may include an N2 interface or an N3 interface. The ng-eNB 1818 may also connect with the 5G core through an NG interface, but may connect with a UE via an LTE air interface. The gNB 1816 and the ng-eNB 1818 may connect with each other over an Xn interface.

In some embodiments, the NG interface may be split into two parts, an NG user plane (NG-U) interface, which carries traffic data between the nodes of the NG-RAN 1814 and a UPF 1848 (e.g., N3 interface), and an NG control plane (NG-C) interface, which is a signaling interface between the nodes of the NG-RAN1814 and an AMF 1844 (e.g., N2 interface).

The NG-RAN 1814 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 1802 can be configured with multiple BWPs where each BWP configuration has a different SCS. When a BWP change is indicated to the UE 1802, the SCS of the transmission is changed as well. Another use case example of BWP is related to power saving. In particular, multiple BWPs can be configured for the UE 1802 with different amount of frequency resources (for example, PRBs) to support data transmission under different traffic loading scenarios. A BWP containing a smaller number of PRBs can be used for data transmission with small traffic load while allowing power saving at the UE 1802 and in some cases at the gNB 1816. A BWP containing a larger number of PRBs can be used for scenarios with higher traffic load.

The RAN 1804 is communicatively coupled to CN 1820 that includes network elements to provide various functions to support data and telecommunications services to customers/subscribers (for example, users of UE 1802). The components of the CN 1820 may be implemented in one physical node or separate physical nodes. In some embodiments, NFV may be utilized to virtualize any or all of the functions provided by the network elements of the CN 1820 onto physical compute/storage resources in servers, switches, etc. A logical instantiation of the CN 1820 may be referred to as a network slice, and a logical instantiation of a portion of the CN 1820 may be referred to as a network sub-slice.

In some embodiments, the CN 1820 may be an LTE CN 1822, which may also be referred to as an EPC. The LTE CN 1822 may include MME 1824, SGW 1826, SGSN 1828, HSS 1830, PGW 1832, and PCRF 1834 coupled with one another over interfaces (or “reference points”) as shown. Functions of the elements of the LTE CN 1822 may be briefly introduced as follows.

The MME 1824 may implement mobility management functions to track a current location of the UE 1802 to facilitate paging, bearer activation/deactivation, handovers, gateway selection, authentication, etc.

The SGW 1826 may terminate an Si interface toward the RAN and route data packets between the RAN and the LTE CN 1822. The SGW 1826 may be a local mobility anchor point for inter-RAN node handovers and also may provide an anchor for inter-3GPP mobility. Other responsibilities may include lawful intercept, charging, and some policy enforcement.

The SGSN 1828 may track a location of the UE 1802 and perform security functions and access control. In addition, the SGSN 1828 may perform inter-EPC node signaling for mobility between different RAT networks; PDN and S-GW selection as specified by MME 1824; MME selection for handovers; etc. The S3 reference point between the MME 1824 and the SGSN 1828 may enable user and bearer information exchange for inter-3GPP access network mobility in idle/active states.

The HSS 1830 may include a database for network users, including subscription-related information to support the network entities' handling of communication sessions. The HSS 1830 can provide support for routing/roaming, authentication, authorization, naming/addressing resolution, location dependencies, etc. An S6a reference point between the HSS 1830 and the MME 1824 may enable transfer of subscription and authentication data for authenticating/authorizing user access to the LTE CN 1820.

The PGW 1832 may terminate an SGi interface toward a data network (DN) 1836 that may include an application/content server 1838. The PGW 1832 may route data packets between the LTE CN 1822 and the data network 1836. The PGW 1832 may be coupled with the SGW 1826 by an S5 reference point to facilitate user plane tunneling and tunnel management. The PGW 1832 may further include a node for policy enforcement and charging data collection (for example, PCEF). Additionally, the SGi reference point between the PGW 1832 and the data network 18 36 may be an operator external public, a private PDN, or an intra-operator packet data network, for example, for provision of IMS services. The PGW 1832 may be coupled with a PCRF 1834 via a Gx reference point.

The PCRF 1834 is the policy and charging control element of the LTE CN 1822. The PCRF 1834 may be communicatively coupled to the app/content server 1838 to determine appropriate QoS and charging parameters for service flows. The PCRF 1832 may provision associated rules into a PCEF (via Gx reference point) with appropriate TFT and QCI.

In some embodiments, the CN 1820 may be a 5GC 1840. The 5GC 1840 may include an AUSF 1842, AMF 1844, SMF 1846, UPF 1848, NSSF 1850, NEF 1852, NRF 1854, PCF 1856, UDM 1858, and AF 1860 coupled with one another over interfaces (or “reference points”) as shown. Functions of the elements of the 5GC 1840 may be briefly introduced as follows.

The AUSF 1842 may store data for authentication of UE 1802 and handle authentication-related functionality. The AUSF 1842 may facilitate a common authentication framework for various access types. In addition to communicating with other elements of the 5GC 1840 over reference points as shown, the AUSF 1842 may exhibit an Nausf service-based interface.

The AMF 1844 may allow other functions of the 5GC 1840 to communicate with the UE 1802 and the RAN 1804 and to subscribe to notifications about mobility events with respect to the UE 1802. The AMF 1844 may be responsible for registration management (for example, for registering UE 1802), connection management, reachability management, mobility management, lawful interception of AMF-related events, and access authentication and authorization. The AMF 1844 may provide transport for SM messages between the UE 1802 and the SMF 1846, and act as a transparent proxy for routing SM messages. AMF 1844 may also provide transport for SMS messages between UE 1802 and an SMSF. AMF 1844 may interact with the AUSF 1842 and the UE 1802 to perform various security anchor and context management functions. Furthermore, AMF 1844 may be a termination point of a RAN CP interface, which may include or be an N2 reference point between the RAN 1804 and the AMF 1844; and the AMF 1844 may be a termination point of NAS (N1) signaling, and perform NAS ciphering and integrity protection. AMF 1844 may also support NAS signaling with the UE 1802 over an N3 IWF interface.

The SMF 1846 may be responsible for SM (for example, session establishment, tunnel management between UPF 1848 and AN 1808); UE IP address allocation and management (including optional authorization); selection and control of UP function; configuring traffic steering at UPF 1848 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 1844 over N2 to AN 1808; and determining SSC mode of a session. SM may refer to management of a PDU session, and a PDU session or “session” may refer to a PDU connectivity service that provides or enables the exchange of PDUs between the UE 1802 and the data network 1836.

The UPF 1848 may act as an anchor point for intra-RAT and inter-RAT mobility, an external PDU session point of interconnect to data network 1836, and a branching point to support multi-homed PDU session. The UPF 1848 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 1848 may include an uplink classifier to support routing traffic flows to a data network.

The NSSF 1850 may select a set of network slice instances serving the UE 1802. The NSSF 1850 may also determine allowed NSSAI and the mapping to the subscribed S-NSSAIs, if needed. The NSSF 1850 may also determine the AMF set to be used to serve the UE 1802, or a list of candidate AMFs based on a suitable configuration and possibly by querying the NRF 1854. The selection of a set of network slice instances for the UE 1802 may be triggered by the AMF 1844 with which the UE 1802 is registered by interacting with the NS SF 1850, which may lead to a change of AMF. The NSSF 1850 may interact with the AMF 1844 via an N22 reference point; and may communicate with another NSSF in a visited network via an N31 reference point (not shown). Additionally, the NSSF 1850 may exhibit an Nnssf service-based interface.

The NEF 1852 may securely expose services and capabilities provided by 3GPP network functions for third party, internal exposure/re-exposure, AFs (e.g., AF 1860), edge computing or fog computing systems, etc. In such embodiments, the NEF 1852 may authenticate, authorize, or throttle the AFs. NEF 1852 may also translate information exchanged with the AF 1860 and information exchanged with internal network functions. For example, the NEF 1852 may translate between an AF-Service-Identifier and an internal 5GC information. NEF 1852 may also receive information from other NFs based on exposed capabilities of other NFs. This information may be stored at the NEF 1852 as structured data, or at a data storage NF using standardized interfaces. The stored information can then be re-exposed by the NEF 1852 to other NFs and AFs, or used for other purposes such as analytics. Additionally, the NEF 1852 may exhibit an Nnef service-based interface.

The NRF 1854 may support service discovery functions, receive NF discovery requests from NF instances, and provide the information of the discovered NF instances to the NF instances. NRF 1854 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 1854 may exhibit the Nnrf service-based interface.

The PCF 1856 may provide policy rules to control plane functions to enforce them, and may also support unified policy framework to govern network behavior. The PCF 1856 may also implement a front end to access subscription information relevant for policy decisions in a UDR of the UDM 1858. In addition to communicating with functions over reference points as shown, the PCF 1856 exhibit an Npcf service-based interface.

The UDM 1858 may handle subscription-related information to support the network entities' handling of communication sessions, and may store subscription data of UE 1802. For example, subscription data may be communicated via an N8 reference point between the UDM 1858 and the AMF 1844. The UDM 1858 may include two parts, an application front end and a UDR. The UDR may store subscription data and policy data for the UDM 1858 and the PCF 1856, and/or structured data for exposure and application data (including PFDs for application detection, application request information for multiple UEs 1802) for the NEF 1852. The Nudr service-based interface may be exhibited by the UDR 221 to allow the UDM 1858, PCF 1856, and NEF 1852 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 1858 may exhibit the Nudm service-based interface.

The AF 1860 may provide application influence on traffic routing, provide access to NEF, and interact with the policy framework for policy control.

In some embodiments, the 5GC 1840 may enable edge computing by selecting operator/3^{rd} party services to be geographically close to a point that the UE 1802 is attached to the network. This may reduce latency and load on the network. To provide edge-computing implementations, the 5GC 1840 may select a UPF 1848 close to the UE 1802 and execute traffic steering from the UPF 1848 to data network 1836 via the N6 interface. This may be based on the UE subscription data, UE location, and information provided by the AF 1860. In this way, the AF 1860 may influence UPF (re)selection and traffic routing. Based on operator deployment, when AF 1860 is considered to be a trusted entity, the network operator may permit AF 1860 to interact directly with relevant NFs. Additionally, the AF 1860 may exhibit an Naf service-based interface.

The data network 1836 may represent various network operator services, Internet access, or third party services that may be provided by one or more servers including, for example, application/content server 1838.

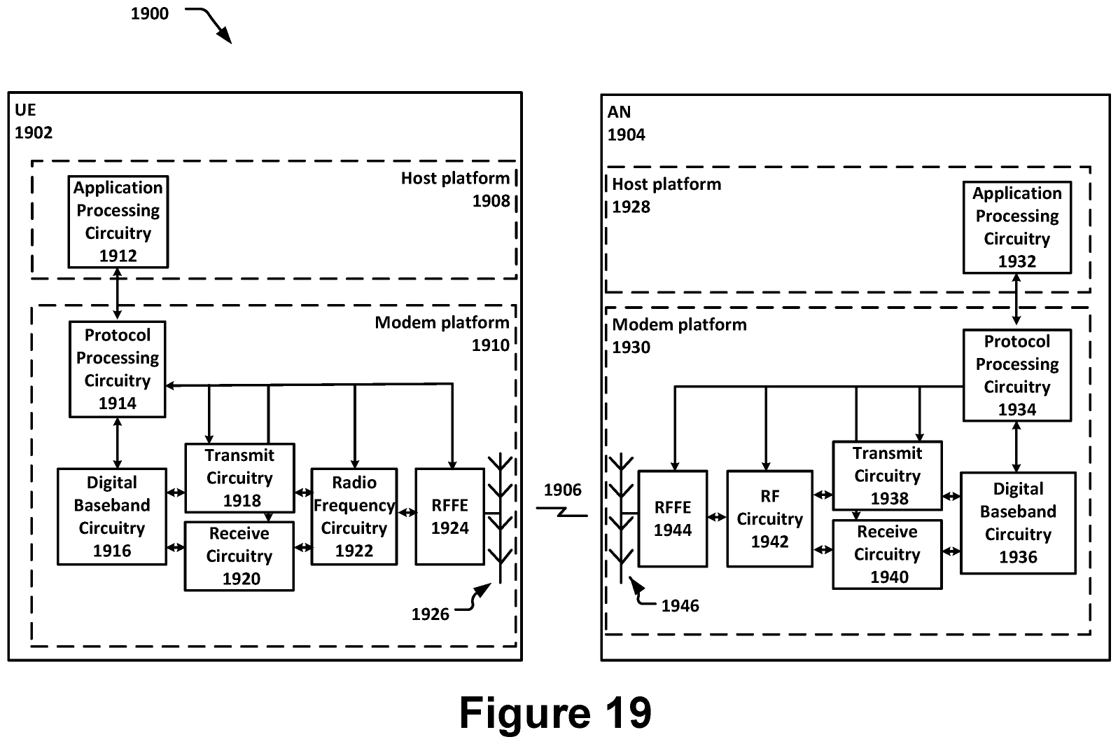

FIG. 19 schematically illustrates a wireless network 1900 in accordance with various embodiments. The wireless network 1900 may include a UE 1902 in wireless communication with an AN 1904. The UE 1902 and AN 1904 may be similar to, and substantially interchangeable with, like-named components described elsewhere herein.

The UE 1902 may be communicatively coupled with the AN 1904 via connection 1906. The connection 1906 is illustrated as an air interface to enable communicative coupling, and can be consistent with cellular communications protocols such as an LTE protocol or a 5G NR protocol operating at mmWave or sub-6 GHz frequencies.

The UE 1902 may include a host platform 1908 coupled with a modem platform 1910. The host platform 1908 may include application processing circuitry 1912, which may be coupled with protocol processing circuitry 1914 of the modem platform 1910. The application processing circuitry 1912 may run various applications for the UE 1902 that source/sink application data. The application processing circuitry 1912 may further implement one or more layer operations to transmit/receive application data to/from a data network. These layer operations may include transport (for example UDP) and Internet (for example, IP) operations

The protocol processing circuitry 1914 may implement one or more of layer operations to facilitate transmission or reception of data over the connection 1906. The layer operations implemented by the protocol processing circuitry 1914 may include, for example, MAC, RLC, PDCP, RRC and NAS operations.

The modem platform 1910 may further include digital baseband circuitry 1916 that may implement one or more layer operations that are “below” layer operations performed by the protocol processing circuitry 1914 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 1910 may further include transmit circuitry 1918, receive circuitry 1920, RF circuitry 1922, and RF front end (RFFE) 1924, which may include or connect to one or more antenna panels 1926. Briefly, the transmit circuitry 1918 may include a digital-to-analog converter, mixer, intermediate frequency (IF) components, etc.; the receive circuitry 1920 may include an analog-to-digital converter, mixer, IF components, etc.; the RF circuitry 1922 may include a low-noise amplifier, a power amplifier, power tracking components, etc.; RFFE 1924 may include filters (for example, surface/bulk acoustic wave filters), switches, antenna tuners, beamforming components (for example, phase-array antenna components), etc. The selection and arrangement of the components of the transmit circuitry 1918, receive circuitry 1920, RF circuitry 1922, RFFE 1924, and antenna panels 1926 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 1914 may include one or more instances of control circuitry (not shown) to provide control functions for the transmit/receive components.

A UE reception may be established by and via the antenna panels 1926, RFFE 1924, RF circuitry 1922, receive circuitry 1920, digital baseband circuitry 1916, and protocol processing circuitry 1914. In some embodiments, the antenna panels 1926 may receive a transmission from the AN 1904 by receive-beamforming signals received by a plurality of antennas/antenna elements of the one or more antenna panels 1926.

A UE transmission may be established by and via the protocol processing circuitry 1914, digital baseband circuitry 1916, transmit circuitry 1918, RF circuitry 1922, RFFE 1924, and antenna panels 1926. In some embodiments, the transmit components of the UE 1904 may apply a spatial filter to the data to be transmitted to form a transmit beam emitted by the antenna elements of the antenna panels 1926.

Similar to the UE 1902, the AN 1904 may include a host platform 1928 coupled with a modem platform 1930. The host platform 1928 may include application processing circuitry 1932 coupled with protocol processing circuitry 1934 of the modem platform 1930. The modem platform may further include digital baseband circuitry 1936, transmit circuitry 1938, receive circuitry 1940, RF circuitry 1942, RFFE circuitry 1944, and antenna panels 1946. The components of the AN 1904 may be similar to and substantially interchangeable with like-named components of the UE 1902. In addition to performing data transmission/reception as described above, the components of the AN 1908 may perform various logical functions that include, for example, RNC functions such as radio bearer management, uplink and downlink dynamic radio resource management, and data packet scheduling.

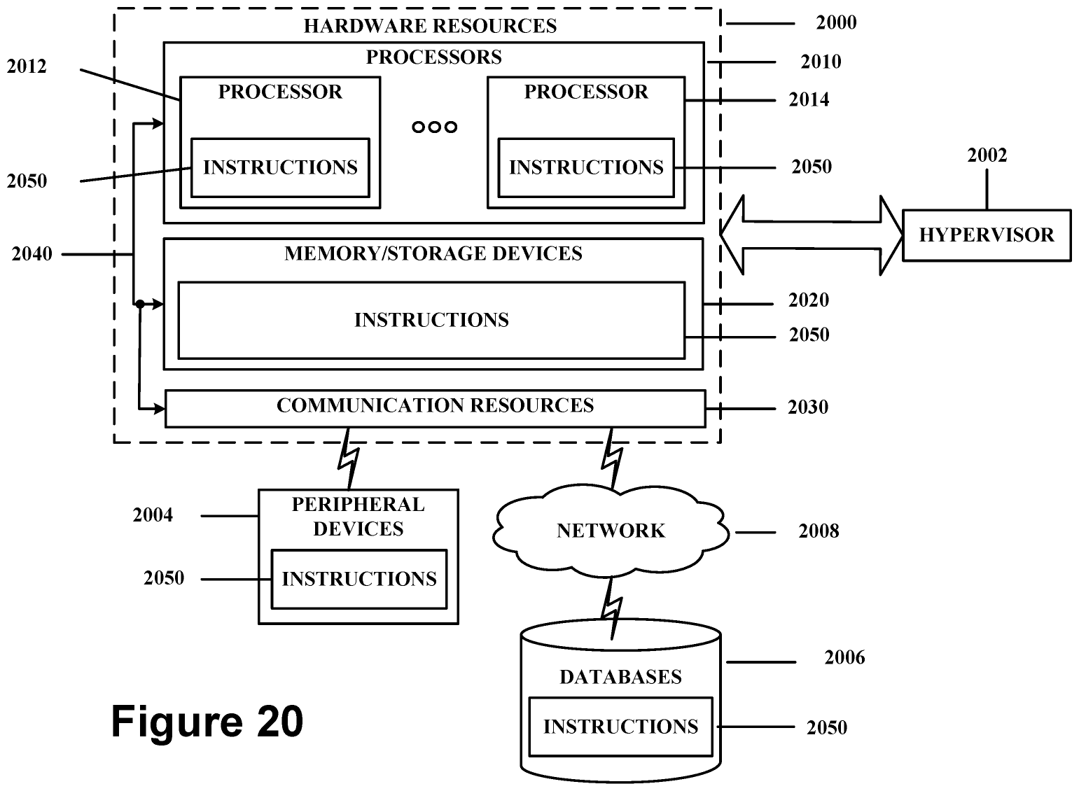

FIG. 20 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 20 shows a diagrammatic representation of hardware resources 2000 including one or more processors (or processor cores) 2010, one or more memory/storage devices 2020, and one or more communication resources 2030, each of which may be communicatively coupled via a bus 2040 or other interface circuitry. For embodiments where node virtualization (e.g., NFV) is utilized, a hypervisor 2002 may be executed to provide an execution environment for one or more network slices/sub-slices to utilize the hardware resources 2000.

The processors 2010 may include, for example, a processor 2012 and a processor 2014. The processors 2010 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 2020 may include main memory, disk storage, or any suitable combination thereof. The memory/storage devices 2020 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 2030 may include interconnection or network interface controllers, components, or other suitable devices to communicate with one or more peripheral devices 2004 or one or more databases 2006 or other network elements via a network 2008. For example, the communication resources 2030 may include wired communication components (e.g., for coupling via USB, Ethernet, etc.), cellular communication components, NFC components, Bluetooth® (or Bluetooth® Low Energy) components, Wi-Fi® components, and other communication components.

Instructions 2050 may comprise software, a program, an application, an applet, an app, or other executable code for causing at least any of the processors 2010 to perform any one or more of the methodologies discussed herein. The instructions 2050 may reside, completely or partially, within at least one of the processors 2010 (e.g., within the processor's cache memory), the memory/storage devices 2020, or any suitable combination thereof. Furthermore, any portion of the instructions 2050 may be transferred to the hardware resources 2000 from any combination of the peripheral devices 2004 or the databases 2006. Accordingly, the memory of processors 2010, the memory/storage devices 2020, the peripheral devices 2004, and the databases 2006 are examples of computer-readable and machine-readable media.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### Examples

Example A.1 may include a method of wireless communication to transmit HARQ-ACK information for above 52.6 GHz carrier frequency.

Example A.2 may include the method of example A.1 and/or some other example herein, wherein UE reports a DTX indication for each DCI in a header of the HARQ-ACK codebook.

Example A.3 may include the method of example A.2 and/or some other example herein, wherein If DTX is not indicated for a DCI, UE indicates the exact number of HARQ-ACK bits for the DL data transmission that is scheduled by the DCI; if DTX is indicated for a DCI, no HARQ-ACK bit is reported for the DCI.

Example A.4 may include the method of example A.2 and/or some other example herein, wherein if the total number of header bits and HARQ-ACK bits exceeds the indicated codebook size, bundling is applied to reduce the number of HARQ-ACK bits.

Example A.5 may include the method of example A.2 and/or some other example herein, wherein the header doesn't include a bit for the last DCI that indicates the UL resource for HARQ-ACK transmission.

Example A.6 may include the method of example A.2 and/or some other example herein, wherein the header indicates whether one or more DCIs scheduling DL data transmissions are detected in M consecutive configured PDCCH monitoring occasions.

Example A.7 may include the method of example A.6 and/or some other example herein, wherein the M consecutive configured PDCCH MOs are determined relative to the last DCI that schedules DL data transmission for which the HARQ-ACK bits are included in the HARQ-ACK codebook.

Example A.8 may include the method of example A.6 and/or some other example herein, wherein the M consecutive configured PDCCH MOs are determined relative to the UL resource that carry the HARQ-ACK information subjected to the necessary PDSCH processing time.

Example A.9 may include the method of examples A.7 or A.8 and/or some other example herein, wherein the value M is semi-statically configured by high layer signaling or dynamically indicated by the last DCI.

Example A.10 may include the method of example A.2 and/or some other example herein, wherein the header indicates whether each DCI in a dynamically determined set of DCIs that schedule DL data transmissions is received by the UE or not.

Example A.11 may include the method of example A.1 and/or some other example herein, wherein the DCI in the set of DCIs are ordered by a counter downlink assignment index (C-DAI).

Example A.12 may include the method of example A.1 and/or some other example herein, wherein the size M of the set of DCIs is derived by the last DCI in the set.

Example A.13 may include the method of example A.1 and/or some other example herein, wherein last DCI for scheduling PDSCHs may also include resource allocation in time and frequency for the PUCCH or PUSCH transmission carrying HARQ-ACK feedback.

Example A.14 may include the method of example A.1 and/or some other example herein, wherein a DCI which is transmitted after the last DCI for scheduling PDSCHs can be used to schedule PUCCH or PUSCH transmission carrying HARQ-ACK feedback.

Example A.15 may include the method of example A.1 and/or some other example herein, wherein more than one DCIs for scheduling a same PUCCH or PUSCH can be transmitted.

Example A.16 may include the method of example A.1 and/or some other example herein, wherein last DCI for scheduling PDSCHs may also include resource allocation in time and frequency for the PUCCH or PUSCH transmission carrying HARQ-ACK feedback.

Example A.17 may include the method of example A.1 and/or some other example herein, wherein a DCI which is transmitted after the last DCI for scheduling PDSCHs can be used to schedule PUCCH or PUSCH transmission carrying HARQ-ACK feedback.

Example A.18 may include the method of example A.1 and/or some other example herein, wherein more than one DCIs for scheduling a same PUCCH or PUSCH can be transmitted.

Example A.19 may include a method comprising:
receiving one or more DCI; and
generating a HARQ-ACK codebook message for transmission, wherein the HARQ-ACK codebook message includes an indication of a number of HARQ-ACK bits associated with individual DCI of the one or more DCI.

Example A.20 may include the method of example A.19 and/or some other example herein, wherein the HARQ-ACK codebook message includes DTX indications to indicate the one or more DCI that were received and one or more other DCI that were not received.

Example A.21 may include the method of example A.19 and/or some other example herein, wherein the HARQ-ACK codebook message does not include an indication of a number of HARQ-ACK bits for the one or more other DCI that were not received.

Example A.22 may include the method of example A.19 and/or some other example herein, wherein the one or more DCI includes a plurality of DCI, and wherein a last DCI of the plurality of DCI includes a include resource allocation for HARQ-ACK feedback associated with PDSCHs scheduled by the plurality of DCI.

Example A.23 may include the method of example A.22 and/or some other example herein, wherein the one or more DCI schedule one or more PDSCHs for transmission, and wherein the method further comprises receiving another DCI after the one or more DCI to schedule a PUCCH or PUSCH transmission carrying HARQ-ACK feedback for the one or more PDSCHs.

Example A.24 may include the method of any of examples A.19-A.23 and/or some other example herein, wherein the one or more DCI include more than one DCI to schedule a same PUCCH or PUSCH.

Example A.25 may include the method of any of examples A19-A.24 and/or some other example herein, wherein the method is performed by a UE or a portion thereof.

Example B.1 may include a method of wireless communication to transmit downlink control information and HARQ-ACK information when multi-PDSCH scheduling is used, comprising:
decoding, by a UE, a DCI from physical downlink control channel (PDCCH);
decoding, by the UE, one or more physical downlink shared channels (PDSCH) which are scheduled by the DCI; and
transmitting, by the UE, a HARQ-ACK codebook which carries HARQ-ACK information for the PDSCH transmissions scheduled by the DCI.

Example B.2 may include the method of example B.1 and/or some other example herein, wherein the HARQ-ACK codebook includes two sub-codebooks.

Example B.3 may include the method of example B.2 and/or some other example herein, wherein the first sub-codebook includes HARQ-ACK bits for TB based PDSCH transmissions scheduled by a single-PDSCH DCI

Example B.4 may include the method of example B.2 and/or some other example herein, wherein the first sub-codebook includes HARQ-ACK bits for TB based PDSCH transmissions scheduled by a DCI that schedules a single PDSCH.

Example B.5 may include the method of example B.2 and/or some other example herein, wherein the first sub-codebook includes HARQ-ACK bits for TB based PDSCH transmissions scheduled by a DCI that schedules one or two TBs.

Example B.6 may include the method of example B.2 and/or some other example herein, wherein in the first sub-codebook, the number of HARQ-ACKs associated with a DCI is 1 or 2.

Example B.7 may include the method of example B.1 and/or some other example herein, wherein the DCI format for all serving cells, irrespective of the configuration of multi-PDSCH scheduling or not, is configured with same size of DAI filed.

Example B.8 may include the method of example B.1 and/or some other example herein, wherein the size of DAI field in a DCI is fixed for a serving cell

Example B.9 may include the method of example B.8 and/or some other example herein, wherein for a first cell configured with TB-based PDSCH transmission and single-PDSCH scheduling, the DAI filed has 2 bits and counts the number of PDCCHs. For a second cell configured with CBG-based PDSCH transmission or multi-PDSCH scheduling, the DAI filed has more than two bits.

Example B.10 may include the method of example B.9 and/or some other example herein, wherein if the associated HARQ-ACK for a multi-PDSCH DCI is included in the first sub-codebook, the DAI in the DCI counts the number of PDCCHs that associates with the first sub-codebook, otherwise, the DAI in the DCI counts the number of PDSCHs or sets of PDSCHs for the second sub-codebook.

Example B.11 may include the method of example B.1 and/or some other example herein, wherein the DAI field in a DCI format has same size for all DCIS that are associated with the same sub-codebook.

Example B.12 may include the method of example B.11 and/or some other example herein, wherein the DAI in a DCI associated with the first sub-codebook has 2 bits, which counts the number of PDCCHs, while the DAI in a DCI associated with the second sub-codebook has more than 2 bits. The DAI in a DCI for the second sub-codebook counts the number of PDSCHs or sets of PDSCHs.

Example B.13 may include the method of example B.12 and/or some other example herein, wherein the size of DAI field in a multi-PDSCH DCI is determined by the sub-codebook that is used to transmit the HARQ-ACKs associated with the DCI.

Example B.14 may include the method of examples B.7-B.13 and/or some other example herein, wherein the size of DAI field is determined by the maximum number of PDSCHs that is schedulable by a DCI among all serving cells.

Example B.15 may include the method of examples B.7-B.13 and/or some other example herein, wherein the size of DAI field is determined by the maximum number of sets of PDSCHs that is schedulable by a DCI among all serving cells.

Example B.16 includes a method comprising:
receiving, by a user equipment (UE), downlink control information (DCI) via a physical downlink control channel (PDCCH);
decoding, by the UE, one or more physical downlink shared channels (PDSCH) which are scheduled by the DCI; and
encoding a message for transmission, by the UE, that includes a hybrid automatic repeat request-acknowledgement (HARQ-ACK) codebook which carries HARQ-ACK information for the one or more PDSCH transmissions scheduled by the DCI.

Example C.1 may include a method of wireless communication for HARQ-ACK codebook size determination when multi-PDSCH scheduling is used, comprising:
decoding, by a UE, a DCI from physical downlink control channel (PDCCH);
decoding, by the UE, one or more physical downlink shared channels (PDSCH) which are scheduled by the DCI; and
transmitting, by the UE, a HARQ-ACK codebook which carries HARQ-ACK information for the PDSCH transmissions scheduled by the DCI.

Example C.2 may include the method of example C.1 and/or some other example herein, wherein C-DAI and T-DAI have the same size in a DCI that schedules PDSCH transmission(s) on a serving cell.

Example C.3 may include the method of example C.1 and/or some other example herein, wherein T-DAI directly indicates the exact size of HARQ-ACK payload.

Example C.4 may include the method of example C.1 and/or some other example herein, wherein T-DAI indicates the quantized HARQ-ACK payload size based on the length, denoted as L of the sequence of HARQ-ACK bits that is generated by the C-DAI.

Example C.5 may include the method of example C.4 and/or some other example herein, wherein T-DAI in the last DCI is set to a lowest T-DAI value Q that is larger than or equal to mod(L,Y),Y=D·(X+1), where D is the maximum number of HARQ-ACK bits that is associated with a PDCCH, X is the maximum number of consecutive missing PDCCHs know to UE.

Example C.6 may include the method of example C.5 and/or some other example herein, wherein the values of T-DAI are Y·t/2^{T}, t=0,1, . . . 2^{T}−1.

Example C.7 may include the method of example C.5 and/or some other example herein, wherein the HARQ-ACK codebook size is Y·└L/Y┘+Q.

Example C.8 may include the method of example C.4 and/or some other example herein, wherein if C-DAI counts the number of PDSCHs, T-DAI in the last DCI is set to a lowest T-DAI value that is larger than or equal to mod(L, 2^{C}·M), where C is the size of C-DAI, M is the maximum number of HARQ bits per PDSCH.

Example C.9 may include the method of example C.4 and/or some other example herein, wherein if C-DAI counts the number of sets of PDSCHs, T-DAI in the last DCI is set to a lowest T-DAI value that is larger than or equal to mod(L, 2^{C}·G), where C is the size of C-DAI, G is the maximum number of HARQ bits per set.

Example C.10 may include the method of examples C.5-C.9 and/or some other example herein, wherein the C-DAI and T-DAI in a DCI that is associated with the first sub-codebook counts the number of PDCCHs.

Example C.11 may include the method of example C.1 and/or some other example herein, wherein the DAI in UL grant indicates the total number of PDSCHs or sets of PDSCHs

Example C.12 may include the method of example C.1 and/or some other example herein, wherein the DAI in UL grant indicates the quantized HARQ-ACK payload size based on the length of the sequence of HARQ-ACK bits that is generated by the C-DAI.

Example C.13 may include the method of example C.1 and/or some other example herein, wherein the DAI field in UL grant that is associated with a sub-codebook has the same size as a T-DAI field in DL assignment for the same sub-codebook

Example C.14 may include the method of example C.1 and/or some other example herein, wherein if there is only one serving cell that is configured with TB-based transmission and single-PDSCH scheduling, T-DAI is not present in a DCI that is associated with the first sub-codebook.

Example C.15 may include the method of example C.1 and/or some other example herein, wherein if there is only one serving cell that is configured with TB-based transmission and single-PDSCH scheduling, T-DAI is not present in a DCI that is associated with the serving cell.

Example C.16 may include the method of example C.1 and/or some other example herein, wherein if there is only one serving cell that is configured with TB-based transmission and single-PDSCH scheduling, and if the first sub-codebook doesn't include the HARQ-ACK bits that are associated with a non-fallback DCI that schedules PDSCH transmissions on a serving cell configured with CBG-based transmission and/or multi-PDSCH scheduling, T-DAI is not present in a DCI that is associated with the first sub-codebook.

Example C.17 may include the method of examples C.1-C.16 and/or some other example herein, wherein The C-DAI counts the number of PDCCHs, or the number of sets of PDSCHs.

Example C.18 includes a method comprising:
receiving, by a user equipment (UE) downlink control information (DCI) via a physical downlink control channel (PDCCH);
determining, by the UE, one or more physical downlink shared channels (PDSCH) which are scheduled by the DCI, wherein the DCI includes an indication of a downlink assignment index counter (C-DAI) and downlink assignment index total (T-DAI) having a common bit size in the DCI; and
encoding a message for transmission, by the UE, that a hybrid automatic repeat request-acknowledgement (HARQ-ACK) codebook which carries HARQ-ACK information for the one or more PDSCH transmissions scheduled by the DCI.

Example D.1 includes a method to be performed by an electronic device associated with a user equipment (UE) of a cellular network, wherein the method comprises:
identifying one or more received downlink control information (DCI) via a physical downlink control channel (PDCCH) transmission;
generating, based on the one or more received DCI, a hybrid automatic repeat request acknowledgement (HARQ-ACK) codebook message for transmission, wherein the HARQ-ACK codebook message includes an indication of a number of HARQ-ACK bits associated with an individual DCI of the one or more DCI; and
facilitating transmission of the HARQ-ACK codebook message.

Example D.2 includes the method of example D.1, and/or some other example herein, wherein the HARQ-ACK codebook message includes one or more indications of discontinuous transmission (DTX), wherein the one or more indications are to indicate that the one or more DCI were received.

Example D.3 includes the method of example D.2, and/or some other example herein, wherein the one or more indications are to further indicate that one or more additional DCI were not received.

Example D.4 includes the method of example D.3, and/or some other example herein, wherein the HARQ-ACK codebook message does not include an indication of a number of HARQ-ACK bits for the one or more additional DCI that were not received.

Example D.5 includes the method of any of examples D.1-D.4, and/or some other example herein, wherein the one or more DCI are a plurality of DCI, and wherein a last DCI of the plurality of DCI includes a resource allocation for HARQ-ACK feedback associated with one or more physical downlink shared channel (PDSCH) transmissions scheduled by the plurality of DCI.

Example D.6 includes the method of any of examples D.1-D.4, and/or some other example herein, wherein the one or more DCI are to schedule one or more physical downlink shared channel (PDSCH) transmissions for transmission, and wherein the method further comprising receiving an additional DCI after the one or more DCI.

Example D.7 includes the method of example D.6, and/or some other example herein, wherein the additional DCI is to schedule a physical uplink control channel (PUCCH) or a physical uplink shared channel (PUSCH) transmission that is to carry HARQ-ACK feedback related to the one or more PDSCH transmissions.

Example D.8 includes the method of any of examples D.1-D.4, and/or some other example herein, wherein the one or more DCI includes at least two DCIs that are to schedule a same physical uplink control channel (PUCCH) or physical uplink shared channel (PUSCH) transmission as one another.

Example D.9 includes the method of any of examples D.1-D.4, and/or some other example herein, wherein the HARQ-ACK codebook is related to a counter downlink assignment index (C-DAI) field in a DCI of the one or more DCI.

Example D.10 includes the method of example D.9, and/or some other example herein, wherein the HARQ-ACK codebook may include an indication of received or unreceived C-DAIs in the one or more DCIs.

Example D.11 includes a method to be performed by an electronic device associated with a user equipment (UE) of a cellular network, wherein the method comprises:
identifying a downlink control information (DCI) received via a physical downlink control channel (PDCCH) transmission;
decoding, based on the DCI, one or more physical downlink shared channel (PDSCH) transmissions, wherein the one or more PDSCH transmissions are scheduled by the DCI;
generating hybrid automatic repeat request acknowledgement (HARQ-ACK) information related to the one or more PDSCH transmissions;
generating a HARQ-ACK codebook based on the HARQ-ACK information; and
facilitating transmission of the HARQ-ACK codebook.

Example D.12 includes the method of example D.11, and/or some other example herein, wherein the HARQ-ACK codebook includes a first sub-codebook and a second sub-codebook.

Example D.13 includes the method of example D.12, and/or some other example herein, wherein the first sub-codebook includes HARQ-ACK information related to PDSCH transmissions scheduled by a DCI that schedules a single PDSCH.

Example D.14 includes the method of any of examples D.12-D.13, and/or some other example herein, wherein the second sub-codebook includes HARQ-ACK information for PDSCH transmissions other than the PDSCH transmissions scheduled by a DCI that schedules a single PDSCH.

Example D.15 includes the method of any of examples D.12-D.14, and/or some other example herein, wherein the second sub-codebook includes HARQ-ACK information related to PDSCH transmissions scheduled by a DCI that schedules a plurality of PDSCH transmissions.

Example D.16 includes the method of any of examples D.12-D.15, and/or some other example herein, wherein the first sub-codebook includes HARQ-ACK information related to a DCI for a serving cell configured transport block (TB)-based PDSCh transmission and single-PDSCH scheduling.

Example D.17 includes the method of any of examples D.12-D.16, and/or some other example herein, wherein the first sub-codebook includes HARQ-ACK information related to a fallback DCI on a serving cell configured with codebook group (CBG)-based transmission or multi-PDSCH scheduling.

Example D.18 includes the method of any of examples D.12-D.17, and/or some other example herein, wherein the first sub-codebook includes HARQ-ACK information related to a multi-PDSCH DCI that schedules a single PDSCH.

Example D.19 includes the method of any of examples D.12-D.18, and/or some other example herein, wherein the first sub-codebook includes HARQ-ACK information related to a DCI that triggers a semi-persistent scheduling (SPS) PDSCH release.

Example D.20 includes the method of any of examples D.12-D.19, and/or some other example herein, wherein the first sub-codebook includes HARQ-ACK information related to a DCI cell that indicates dormancy of a secondary cell (SCell).

Example Z01 may include an apparatus comprising means to perform one or more elements of a method described in or related to any of examples A.1-D.20, or any other method or process described herein.

Example Z02 may include one or more non-transitory computer-readable media comprising instructions to cause an electronic device, upon execution of the instructions by one or more processors of the electronic device, to perform one or more elements of a method described in or related to any of examples A.1-D.20, or any other method or process described herein.

Example Z03 may include an apparatus comprising logic, modules, or circuitry to perform one or more elements of a method described in or related to any of examples A.1-D.20, or any other method or process described herein.

Example Z04 may include a method, technique, or process as described in or related to any of examples A.1-D.20, or portions or parts thereof.

Example Z05 may include an apparatus comprising: one or more processors and one or more computer-readable media comprising instructions that, when executed by the one or more processors, cause the one or more processors to perform the method, techniques, or process as described in or related to any of examples A.1-D.20, or portions thereof.

Example Z06 may include a signal as described in or related to any of examples A.1-D.20, or portions or parts thereof.

Example Z07 may include a datagram, packet, frame, segment, protocol data unit (PDU), or message as described in or related to any of examples A.1-D.20, or portions or parts thereof, or otherwise described in the present disclosure.

Example Z08 may include a signal encoded with data as described in or related to any of examples A.1-D.20, or portions or parts thereof, or otherwise described in the present disclosure.

Example Z09 may include a signal encoded with a datagram, packet, frame, segment, protocol data unit (PDU), or message as described in or related to any of examples A.1-D.20, or portions or parts thereof, or otherwise described in the present disclosure.

Example Z10 may include an electromagnetic signal carrying computer-readable instructions, wherein execution of the computer-readable instructions by one or more processors is to cause the one or more processors to perform the method, techniques, or process as described in or related to any of examples A.1-D.20, or portions thereof.

Example Z11 may include a computer program comprising instructions, wherein execution of the program by a processing element is to cause the processing element to carry out the method, techniques, or process as described in or related to any of examples A.1-D.20, or portions thereof.

Example Z12 may include a signal in a wireless network as shown and described herein. Example Z13 may include a method of communicating in a wireless network as shown and described herein.

Example Z14 may include a system for providing wireless communication as shown and described herein.

Example Z15 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### Abbreviations

Unless used differently herein, terms, definitions, and abbreviations may be consistent with terms, definitions, and abbreviations defined in 3GPP TR 21.905 v16.0.0 (2019-06). For the purposes of the present document, the following abbreviations may apply to the examples and embodiments discussed herein.

| | |
|---|---|
| 3GPP | Third Generation Partnership Project |
| 4G | Fourth Generation |
| 5G | Fifth Generation |
| 5GC | 5G Core network |
| AC | Application Client |
| ACK | Acknowledgement |
| ACID | Application Client Identification |
| AF | Application Function |
| AM | Acknowledged Mode |
| AMBR | Aggregate Maximum Bit Rate |
| AMF | Access and Mobility Management Function |
| AN | Access Network |
| ANR | Automatic Neighbour Relation |
| AP | Application Protocol, Antenna Port, Access Point |
| API | Application Programming Interface |
| APN | Access Point Name |
| ARP | Allocation and Retention Priority |
| ARQ | Automatic Repeat Request |
| AS | Access Stratum |
| ASP | Application Service Provider |
| ASN.1 | Abstract Syntax Notation One |
| AUSF | Authentication Server Function |
| AWGN | Additive White Gaussian Noise |
| BAP | Backhaul Adaptation Protocol |
| BCH | Broadcast Channel |
| BER | Bit Error Ratio |
| BFD | Beam Failure Detection |
| BLER | Block Error Rate |
| BPSK | Binary Phase Shift Keying |
| BRAS | Broadband Remote Access Server |
| BSS | Business Support System |
| BS | Base Station |
| BSR | Buffer Status Report |
| BW | Bandwidth |
| BWP | Bandwidth Part |
| C-RNTI | Cell Ratio Network Temporary Identity |
| CA | Carrier Aggregation, Certification Authority |
| CAPEX | CAPital EXpenditure |
| CBRA | Contention Based Random Access |
| CC | Component Carrier, Country Code, |
| | Cryptographic Checksum |
| CCA | Clear Channel Assessment |
| CCE | Control Channel Element |
| CCCH | Common Control Channel |
| CE | Coverage Enhancement |
| CDM | Content Delivery Network |
| CDMA | Code-Division Multiple Access |
| CFRA | Contention Free Random Access |
| CG | Cell Group |
| CGF | Charging Gateway Function |
| CHF | Charging Function |
| CI | Cell Identity |
| CID | Cell-ID (e.g., positioning method) |
| CIM | Common Information Model |
| CIR | Carrier to Interference Ratio |
| CK | Cipher Key |
| CM | Connection Management, Conditional Mandatory |
| CMAS | Commercial Mobile Alert Service |
| CMD | Command |
| CMS | Cloud Management System |
| CO | Conditional Optional |
| CoMP | Coordinated Multi-Point |
| CORESET | Control Resource Set |
| COTS | Commercial Off-The-Shelf |
| CP | Control Plane, Cyclic Prefix, Connection Point |
| CPD | Connection Point Descriptor |
| CPE | Customer Premise Equipment |
| CPICH | Common Pilot Channel |
| CQI | Channel Quality Indicator |
| CPU | CSI processing unit, Central Processing Unit |
| C/R | Command/Response field bit |
| CRAN | Cloud Radio Access Network, Cloud RAN |
| CRB | Common Resource Block |
| CRC | Cyclic Redundancy Check |
| CRI | Channel-State Information Resource Indicator, |
| | CSI-RS Resource Indicator |
| C-RNTI | Cell RNTI |
| CS | Circuit Switched |
| CSCF | call session control function |
| CSAR | Cloud Service Archive |
| CSI | Channel-State Information |
| CSI-IM | CSI Interference Measurement |
| CSI-RS | CSI Reference Signal |
| CSI-RSRP | CSI reference signal received power |
| CSI-RSRQ | CSI reference signal received quality |
| CSI-SINR | CSI signal-to-noise and interference ratio |
| CSMA | Carrier Sense Multiple Access |
| CSMA/CA | CSMA with collision avoidance |
| CSS | Common Search Space, Cell-specific Search Space |
| CTF | Charging Trigger Function |
| CTS | Clear-to-Send |
| CW | Codework |
| CWS | Contenction Window Size |
| D2D | Device-to-Device |
| DC | Dual Connectivity, Direct Current |
| DCI | Downlink Control Information |
| DF | Deployment Flavour |
| DL | Downlink |
| DMTF | Distributed Management Task Force |
| DPDK | Data Plane Development Kit |
| DM-RS, | Demodulation Reference Signal |
| DMRS | |
| DN | Data network |
| DNN | Data Network Name |
| DNAI | Data Network Access Identifier |
| DRB | Data Radio Bearer |
| DRS | Discovery Reference Signal |
| DRX | Discontinuous Reception |
| DSL | Domain Specific Language. Digital Subsciber Line |
| DSLAM | DSL Acess Multiplexer |
| DwPTS | Downlink Pilot Time Slot |
| E-LAN | Ethernet Local Area Network |
| E2E | End-to-End |
| ECCA | extended clear channel assessment, extended CCA |
| ECCE | Enhanced Control Channel Element, Enhanced CCE |
| ED | Energy Detection |
| EDGE | Enhanced Catarates for GSM Evolution |
| | (GSM Evolution) |
| EAS | Edge Application Server |
| EASID | Edge Application Server Identification |
| ECS | Edge Configuration Server |
| ECSP | Edge Computing Service Provider |
| EDN | Edge Data Network |
| EEC | Edge Enabler Client |
| EECID | Edge Enabler Client Identification |
| EES | Edge Enabler Server |
| EESID | Edge Enabler Server Identification |
| EHE | Edge Hosting Environment |
| EGMF | Exposure Governance Management Function |
| EGPRS | Enhanced GPRS |
| EIR | Equipment Identity Register |
| eLAA | enhanced Licensed Assisted Access, enhanced LAA |
| EM | Element Manager |
| eMBB | Enhanced Mobile Broadband |
| EMS | Element Management System |
| eNB | evolved NodeB, E-UTRAN Node B |
| EN-DC | E-UTRA-NR Dual Connectivity |
| EPC | Evolved Packet Core |
| EPDCCH | enhanced PDCCH, enhanced Physical Downlink |
| | Control Cannel |
| EPRE | Energy per resource element |
| EPS | Evolved Packet System |
| EREG | enhanced REG, enhanced resource element groups |
| ETSI | European Telecommunications Standards Institute |
| ETWS | Earthquake and Tsunami Warning System |
| eUICC | embedded UICC, embedded Universal Integrated |
| | Circuit Card |
| E-UTRA | Evolved UTRA |
| E-UTRAN | Evolved UTRAN |
| EV2X | Enhanced V2X |
| F1AP | F1 Application Protocol |
| F1-C | F1 Control plane interface |
| F1-U | F1 User plane interface |
| FACCH | Fast Associated Control CHannel |
| FACCH/F | Fast Associated Control Channel/Full rate |
| FACCH/H | Fast Associated Control Channel/Half rate |
| FACH | Forward Access Channel |
| FAUSCH | Fast Uplink Signalling Channel |
| FB | Functional Block |
| FBI | Feedback Information |
| FCC | Federal Communications Commission |
| FCCH | Frequency Correction CHannel |
| FDD | Frequency Division Duplex |
| FDM | Frequency Division Multiplex |
| FDMA | Frequency Division Multiple Access |
| FE | Front End |
| FEC | Forward Error Correction |
| FFS | For Further Study |
| FFT | Fast Fourier Transformation |
| feLAA | further enhanced Licensed Assisted Access, |
| | further enhanced LAA |
| FN | Frame Number |
| FPGA | Field-Programmable Gate Array |
| FR | Frequency Range |
| FQDN | Fully Qualified Domain Name |
| G-RNTI | GERAN Radio Network Temporary Identity |
| GERAN | GSM EDGE RAN, GSM EDGE Radio Access |
| | Network |
| GGSN | Gateway GPRS Support Node |
| GLONASS | GLObal'naya NAvigatsionnaya Sputnikovaya |
| | Sistema (Engl.: Global Naviation Satellite System) |
| gNB | Next Generation NodeB |
| gNB-CU | gNB-centralized unit, Next Generation |
| | NodeB centralized unit |
| gNB-DU | gNB-distributed unit, Next Generation |
| | NodeB distributed unit |
| GNSS | Global Navigation Satellite System |
| GPRS | General Packet Radio Service |
| GPSI | Generic Public Subscription Identifier |
| GSM | Global System for Mobile Communications, |
| | Groupe Spécial Mobile |
| GTP | GPRS Tunneling Protocol |
| GTP-UGPRS | Tunnelling Protocol for User Plane |
| GTS | Go To Sleep Signal (related to WUS) |
| GUMMEI | Globally Unique MME Identifier |
| GUTI | Globally Unique Temporary UE Identity |
| HARQ | Hybrid ARQ, Hybrid Automatic Repeat Request |
| HANDO | Handover |
| HFN | HyperFrame Number |
| HHO | Hard Handover |
| HLR | Home Location Register |
| HN | Home Network |
| HO | Handover |
| HPLMN | Home Public Land Mobile Network |
| HSDPA | High Speed Downlink Packet Access |
| HSN | Hopping Sequence Number |
| HSPA | High Speed Packet Access |
| HSS | Home Subscriber Server |
| HSUPA | High Speed Uplink Packet Access |
| HTTP | Hyper Text Transfer Protocol |
| HTTPS | Hyper Text Transfer Protocol Secure (https is http/ |
| | 1.1 over SSL, i.e. port 443) |
| I-Block | Information Block |
| ICCID | Integrated Circuit Card Identification |
| IAB | Integrated Access and Backhaul |
| ICIC | Inter-Cell Interference Coordination |
| ID | Identity, identifier |
| IDFT | Inverse Discrete Fourier Transform |
| IE | Information element |
| IBE | In-Band Emission |
| IEEE | Institute of Electrical and Electronics Engineers |
| IEI | Information Element Identifier |
| IEIDL | Information Element Identifier Data Length |
| IETF | Internet Engineering Task Force |
| IF | Infrastructure |
| IM | Interference Measurement, Intermodulation, |
| | IP Multimedia |
| IMC | IMS Credentials |
| IMEI | International Mobile Equipment Identity |
| IMGI | International mobile group identity |
| IMPI | IP Multimedia Private Identity |
| IMPU | IP Multimedia PUblic identity |
| IMS | IP Multimedia Subsystem |
| IMSI | International Mobile Subscriber Identity |
| IoT | Internet of Things |
| IP | Internet Protocol |
| IP-CAN | IP-Connectivity Access Network |
| IP-M | IP Multicast |
| IPv4 | Internet Protocol Version 4 |
| IPv6 | Internet Protocol Version 6 |
| IR | Infrared |
| IS | In Sync |
| IRP | Integration Reference Point |
| ISDN | Integrated Services Digital Network |
| ISIM | IM Services Identity Module |
| ISO | International Organisation for Standardisation |
| ISP | Internet Service Provider |
| IWF | Interworking-Function |
| I-WLAN | Interworking WLAN Constraint length of the |
| | convolutional code, USIM Individual key |
| kB | Kilobyte (1000 bytes) |
| kbps | kilo-bits per second |
| Kc | Ciphering key |
| Ki | Individual subscriber authentication key |
| KPI | Key Performance Indicator |
| KQI | Key Quality Indicator |
| KSI | Key Set Identifier |
| ksps | kilo-symbols per second |
| KVM | Kernel Virtual Machine |
| L1 | Layer 1 (physical layer) |
| L1-RSRP | Layer 1 reference signal received power |
| L2 | Layer 2 (data link layer) |
| L3 | Layer 3 (network layer) |
| LAA | Licensed Assisted Access |
| LAN | Local Area Network |
| LADN | Local Area Data Network |
| LBT | Listen Before Talk |
| LCM | LifeCycle Management |
| LCR | Low Chip Rate |
| LCS | Location Services |
| LCID | Logical Channel ID |
| LI | Layer Indicator |
| LLC | Logical Link Control, Low Layer Compatibility |
| LPLMN | Local PLMN |
| LPP | LTE Positioning Protocol |
| LSB | Least Significant Bit |
| LTE | Long Term Evolution |
| LWA | LTE/WLAN aggregation |
| LWIP | LTE/WLAN Radio Level Integration with IPsec |
| | Tunnel |
| LTE | Long Term Evolution |
| M2M | Machine-to-Machine |
| MAC | Medium Access Control (protocol layering context) |
| MAC | Message authenticaiton code (security/encryption |
| | context) |
| MAC-A | MAC used for authentication and key agreement |
| | (TSG T WG3 context) |
| MAC-IMAC | used for data integrity of signalling messages |
| | (TSG T WG3 context) |
| MANO | Management and Orchestration |
| MBMS | Multimedia Broadcast and Multicast Service |
| MBSFN | Multimedia Broadcast multicast service Single |
| | Frequency Network |
| MCC | Mobile Country Code |
| MCG | Master Cell Group |
| MCOT | Maximum Channel Occupancy Time |
| MCS | Modulation and coding scheme |
| MDAF | Management Data Analytics Function |
| MDAS | Management Data Analytics Service |
| MDT | Minimization of Drive Tests |
| ME | Mobile Equipment |
| MeNB | master eNB |
| MER | Message Error Ratio |
| MGL | Measurement Gap Length |
| MGRP | Measurement Gap Repetition Period |
| MIB | Master Information Block, Management |
| | Information Base |
| MIMO | Multiple Input Multiple output |
| MLC | Mobile Location Centre |
| MM | Mobility Management |
| MME | Mobility Management Entity |
| MN | Master Node |
| MNO | Mobile Network Operator |
| MO | Measurement Object, Mobile Originated |
| MPBCH | MTC Physical Broadcase CHannel |
| MPDCCH | MTC Physical Downlink Control CHannel |
| MPDSCH | MTC Physical Downlink Shared CHannel |
| MPRACH | MTC Physical Random Access CHannel |
| MPUSCH | MTC Physical Uplink Shared Channel |
| MPLS | MultiProtocol Label Switching |
| MS | Mobile Station |
| MSB | Most Significant Bit |
| MSC | Mobile Switching Centre |
| MSI | Minimum System Information, MCH Scheduling |
| | Information |
| MSID | Mobile Station Identifier |
| MSIN | Mobile Station Identification Number |
| MSISDN | Mobile Subscriber ISDN Number |
| MT | Mobile Terminated, Mobile Termination |
| MTC | Machine-Type Communications mMTCmassive |
| | MTC, massive Machine-Type Communications |
| MU-MIMO | Multi User MIMO |
| MWUS | MTC wake-up signal, MTC WUS |
| NACK | Negative Acknowledgement |
| NAI | Network Access Identifier |
| NAS | Non-Access Stratum, Non-Access Stratum layer |
| NCT | Network Connectivity Topology |
| NC-JT | Non-Coherent Joint Transmission |
| NEC | Network Capability Exposure |
| NE-DC | NR-E-UTRA Dual Connectivity |
| NEF | Network Exposure Function |
| NF | Network Function |
| NFP | Network Forwarding Path |
| NFPD | Network Forwarding Path Descriptor |
| NFV | Network Functions Virtualization |
| NFVI | NFV Infrastructure |
| NFVO | NFV Orchestrator |
| NG | Next Generation, Next Gen |
| NGEN-DC | NG-RAN E-UTRA-NR Dual Connectivity |
| NM | Network Manager |
| NMS | Network Management System |
| N-PoP | Network Point of Presence |
| NMIB, | Narrowband MIB |
| N-MIB | |
| NPBCH | Narrowband Physical Broadcast CHannel |
| NPDCCH | Narrowband Physical Downlink Control CHannel |
| NPDSCH | Narrowband Physical Downlink Shared CHannel |
| NPRACH | Narrowband Physical Random Access CHannel |
| NPUSCH | Narrowband Physical Uplink Shared CHannel |
| NPSS | Narrowband Primary Synchronization Signal |
| NSSS | Narrowband Secondary Synchronization Signal |
| NR | New Radio, Neighbour Relation |
| NRF | NF Repository Function |
| NRS | Narrowband Reference Signal |
| NS | Network Service |
| NSA | Non-Standalone operation mode |
| NSD | Network Service Descriptor |
| NSR | Network Service Record |
| NSSAI | Network Slice Selection Assistance Information |
| S-NNSAI | Single-NSSAI |
| NSSF | Network Slice Selction Function |
| NW | Network |
| NWUS | Narrowband wake-up signal, Narrowband WUS |
| NZP | Non-Zero Power O&M Operation and Maintenance |
| ODU2 | Optical channel Data Unit—type 2 |
| OFDM | Orthogonal Frequency Division Multiplexing |
| OFDMA | Orthogonal Frequency Division Multiple Access |
| OOB | Out-of-band |
| OOS | Out of Sync |
| OPEX | OPerating EXpense |
| OSI | Other System Information |
| OSS | Operations Support System |
| OTA | over-the-air |
| PAPR | Peak-to-Average Power Ratio |
| PAR | Peak to Average Ratio |
| PBCH | Physical Broadcast Channel |
| PC | Power Control, Personal Computer |
| PCC | Primary Component Carrier, Primary CC |
| P-CSCF | Proxy CSCF |
| PCell | Primary Cell |
| PCI | Physical Cell ID, Physical Cell Identity |
| PCEF | Policy and Charging Enforcement Function |
| PCF | Policy Control Function |
| PCRF | Policy Control and Charging Rules Function |
| PDCP | Packet Data Convergence Protocol, Packet Data |
| | Convergence Protocol layer |
| PDCCH | Physical Downlink Control Channel |
| PDCP | Packet Data Convergence Protocol |
| PDN | Packet Data Network, Public Data Network |
| PDSCH | Physical Downlink Shared Channel |
| PDU | Protocol Data Unit |
| PEI | Permanent Equipment Identifiers |
| PFD | Packet Flow Description |
| P-GW | PDN Gateway |
| PHICH | Physical hybrid-ARQ indicator channel |
| PHY | Physical layer |
| PLMN | Public Land Mobile Network |
| PIN | Personal Identificaiton Number |
| PM | Performance Measurement |
| PMI | Precoding Matrix Indicator |
| PNF | Physical Network Function |
| PNFD | Physical Network Function Descriptor |
| PNFR | Physical Network Function Record |
| POC | PTT over Cellular |
| PP, PTP | Point-to-Point |
| PPP | Point-to-Point Protocol |
| PRACH | Physical RACH |
| PRB | Physical resource block |
| PRG | Physical resource block group |
| ProSe | Proximity Services, Proximity-Based Service |
| PRS | Positioning Reference Signal |
| PRR | Packet Reception Radio |
| PS | Packet Services |
| PSBCH | Physical Sidelink Broadcast Channel |
| PSDCH | Physical Sidelink Downlink Channel |
| PSCCH | Physical Sideline Control Channel |
| PSSCH | Physical Sidelink Shared Channel |
| PsCell | Primary SCell |
| PSS | Primary Synchronization Signal |
| PSTN | Public Switched Telephone Network |
| PT-RS | Phase-tracking reference signal |
| PTT | Push-to-Talk |
| PUCCH | Physical Uplink Control Channel |
| PUSCH | Physical Uplink Shared Channel |
| QAM | Quadrature Amplitude Modulation |
| QCI | QoS class of identifier |
| QCL | Quasi co-location |
| QFI | QoS Flow ID, QoS Quality of Service |
| QPSK | Quadrature (Quaternary) Phase Shift Keying |
| QZSS | Quasi-Zenith Satellite System |
| RA-RNTI | Random Access RNTI |
| RAB | Radio Access Bearer, Random Access Burst |
| RACH | Random Access Channel |
| RADIUS | Remote Authentication Dial In User Service |
| RAN | Radio Access Network |
| RAND | RANDom number (used for authentication) |
| RAR | Random Access Response |
| RAT | Radio Access Technology |
| RAU | Routing Area Update |
| RB | Resource block, Radio Bearer |
| RBG | Resource block group |
| REG | Resource Element Group |
| Rel | Release |
| REQ | REQuest |
| RF | Radio Frequency |
| RI | Rank Indicator |
| RIV | Resource indicator value |
| RL | Radio Link |
| RLC | Radio Link Control, Radio Link Control layer |
| RLC AM | RLC Acknowledged Mode |
| RLC UM | RLC Unacknowledged Mode |
| RLF | Radio Link Railure |
| RLM | Radio Link Monitoring |
| RLM-RS | Reference Signal for RLM |
| RM | Registration Management |
| RMC | Reference Measurement Channel |
| RMSI | Remaining MSI, Remaining Minimum System |
| | Information |
| RN | Relay Node |
| RNC | Radio Network Controller |
| RNL | Radio Network Layer |
| RNTI | Radio Network Temporary Identifier |
| ROHC | RObust Header Compression |
| RRC | Radio Resource Control, Radio Resource Control |
| | layer |
| RRM | Radio Resource Management |
| RS | Reference Signal |
| RSRP | Reference Signal Received Power |
| RSRQ | Reference Signal Received Quality |
| RSSI | Received Signal Strength Indicator |
| RSU | Road Side Unit |
| RSTD | Reference Signal Time difference |
| RTP | Real Time Protocol |
| RTS | Ready-To-Send |
| RTT | Round Trip Time |
| Rx | Reception, Receiving, Receiver |
| S1AP | S1 Application Protocol |
| S1-MME | S1 for the control plane |
| S1-U | S1 for the user plane |
| S-CSCF | serving CSCF |
| S-GW | Serving Gateway |
| S-RNTI | SRNC Radio Network Temporary Identity |
| S-TMSI | SAE Temporary Mobile Station Identifier |
| SA | Standalone operation mode |
| SAE | System Architecture Evolution |
| SAP | Service Access Point |
| SAPD | Service Access Point Descriptor |
| SAPI | Service Access Point Identifier |
| SCC | Secondary Component Carrier, Secondary CC |
| SCell | Secondary Cell |
| SCEF | Service Capability Exposure Function |
| SC-FDMA | Single Carrier Frequency Division Multiple Access |
| SCG | Secondary Cell Group |
| SCM | Security Context Management |
| SCS | Subcarrier Spacing |
| SCTP | Stream Control Transmission Protocol |
| SDAP | Service Data Adaptation Protocol, Service Data |
| | Adaptation Protocol layer |
| SDL | Supplementary Downlink |
| SDNF | Structured Data Storage Network Function |
| SDP | Session Description Protocol |
| SDSF | Structured Data Storage Function |
| SDU | Service Data Unit |
| SEAF | Security Anchor Function |
| SeNB | secondary eNB |
| SEPP | Security Edge Protection Proxy |
| SFI | Slot format indication |
| SFTD | Space-Frequency Time Diversity, SFN and |
| | frame timing difference |
| SFN | System Frame Number |
| SgNB | Secondary gNB |
| SGSN | Serving GPRS Support Node |
| S-GW | Serving Gateway |
| SI | System Information |
| SI-RNTI | System Information RNTI |
| SIB | System Information Block |
| SIM | Subscriber Identity Module |
| SIP | Session Initiated Protocol |
| SiP | System in Package |
| SL | Sidelink |
| SLA | Service Level Agreement |
| SM | Session Management |
| SMF | Session Management Function |
| SMS | Short Message Service |
| SMSF | SMS Function |
| SMTC | SSB-based Meausrement Timing Configuration |
| SN | Secondary Node, Sequence Number |
| SoC | System on Chip |
| SON | Self-Organizing Network |
| SpCell | Special Cell |
| SP-CSI-RNTI | Semi-Persistent CSI RNTI |
| SPS | Semi-Persistent Scheduling |
| SQN | Sequence number |
| SR | Scheduling Request |
| SRB | Signalling Radio Bearer |
| SRS | Sounding Reference Signal |
| SS | Synchronization Signal |
| SSB | Synchronixation Signal Block |
| SSID | Service Set Identifier |
| SS/PBCH | Block |
| SSBRI | SS/PBCH Block Resource Indicator, |
| | Synchronization Signal Block Resource Indicator |
| SSC | Session and Service Continuity |
| SS-RSRP | Synchronization Signal based Reference |
| | Signal Received Power |
| SS-RSRQ | Synchronization Signal based Reference |
| | Signal Received Quality |
| SS-SINR | Synchronization Signal based Signal to |
| | Noise and Interference Ratio |
| SSS | Secondary Synchronization Signal |
| SSSG | Search Space Set Group |
| SSSIF | Search Space Set Indicatory |
| SST | Slice/Service Types |
| SU-MIMO | Single User MIMO |
| SUL | Supplementary Uplink |
| TA | Timing Advance, Tracking Area |
| TAC | Tracking Area Code |
| TAG | Timing Advance Group |
| TAI | Tracking Area Identity |
| TAU | Tracking Area Update |
| TB | Transport Block |
| TBS | Transport Block Size |
| TBD | To Be Defined |
| TCI | Transmission Configuration Indicatory |
| TCP | Transmission Communication Protocol |
| TDD | Time Division Duplex |
| TDM | Time Division Multiplexing |
| TDMA | Time Division Multiple Access |
| TE | Terminal Equipment |
| TEID | Tunnel End Point Identifier |
| TFT | Traffic Flow Template |
| TMSI | Temporary Mobile Subscriber Identity |
| TNL | Transport Network Layer |
| TPC | Transmit Power Control |
| TPMI | Transmitted Precoding Matrix Indicator |
| TR | Technical Report |
| TRP, TRxP | Transmission Reception Point |
| TRS | Tracking Reference Signal |
| TRx | Transceiver |
| TS | Technical Specifications, Technical Standard |
| TTI | Transmission Time Interval |
| Tx | Transmission, Transmitting, Transmitter |
| U-RNTI | UTRAN Radio Network Temporary Identity |
| UART | Universal Asynchronous Receiver and Transmitter |
| UCI | Uplink Control Information |
| UE | User Equipment |
| UDM | Unified Data Management |
| UDP | User Datagram Protocol |
| UDSF | Unstructured Data Storage Network Function |
| UICC | Universal Integrated Circuit Card |
| UL | Uplink |
| UM | Unacknowledged Mode |
| UML | Unified Modelling Language |
| UMTS | Universal Mobile Telecommunications System |
| UP | User Plane |
| UPF | User Plane Function |
| URI | Uniform Resource Identifier |
| URL | Uniform Resource Locator |
| URLLC | Ultra-Reliable and Low Latency |
| USB | Universal Serial Bus |
| USIM | Universal Subscriber Identity Module |
| USS | UE-specific search space |
| UTRA | UMTS Terrestrial Radio Access |
| UTRAN | Universal Terrestrial Radio Access Network |
| UwPTS | Uplink Pilot Time Slot |
| V2I | Vehicle-to-Infrastruction |
| V2P | Vehicle-to-Pedestrian |
| V2V | Vehicle-to-Vehicle |
| V2X | Vehicle-to-everything |
| VIM | Virtualized Infrastructure Manager |
| VL | Virtual Link, |
| VLAN | Virtual Lan, Virtual Local Area Network |
| VM | Virtual Machine |
| VNF | Virtualized Network Function |
| VNFFG | VNF Forwarding Graph |
| VNFFGD | VNF Forwarding Graph Descriptor |
| VNFM | VNF Manager |
| VoIP | Voice-over-IP, Voice-over-Internet Protocol |
| VPLMN | Visited Public Land Mobile Network |
| VPN | Virtual Private Network |
| VRB | Virtual Resource Block |
| WiMAX | Worldwide Interoperability for Microwave Access |
| WLAN | Wireless Local Area Network |
| WMAN | Wireless Metropolitan Area Network |
| WPAN | Wireless Personal Area Network |
| X2-C | X2-Control plane |
| X2-U | X2-User plane |
| XML | eXtensible Markup Language |
| XRES | EXpected user RESponse |
| XOR | eXclusive OR |
| ZC | Zadoff-Chu |
| ZP | Zero Power |

### Terminology

For the purposes of the present document, the following terms and definitions are applicable to the examples and embodiments discussed herein.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes.

Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

The term “SMTC” refers to an SSB-based measurement timing configuration configured by SSB-MeasurementTimingConfiguration.

The term “SSB” refers to an SS/PBCH block.

The term “a “Primary Cell” refers to the MCG cell, operating on the primary frequency, in which the UE either performs the initial connection establishment procedure or initiates the connection re-establishment procedure.

The term “Primary SCG Cell” refers to the SCG cell in which the UE performs random access when performing the Reconfiguration with Sync procedure for DC operation.

The term “Secondary Cell” refers to a cell providing additional radio resources on top of a Special Cell for a UE configured with CA.

The term “Secondary Cell Group” refers to the subset of serving cells comprising the PSCell and zero or more secondary cells for a UE configured with DC.

The term “Serving Cell” refers to the primary cell for a UE in RRC_CONNECTED not configured with CA/DC there is only one serving cell comprising of the primary cell.

The term “serving cell” or “serving cells” refers to the set of cells comprising the Special Cell(s) and all secondary cells for a UE in RRC_CONNECTED configured with CA/DC.

The term “Special Cell” refers to the PCell of the MCG or the PSCell of the SCG for DC operation; otherwise, the term “Special Cell” refers to the Pcell.

1.-20. (canceled)

21. A user equipment (UE) comprising:
memory to store one or more downlink control information (DCI) received via a physical downlink control channel (PDCCH) transmission; and
one or more processors configured to:
generate, based on the one or more received DCI, a hybrid automatic repeat request acknowledgement (HARQ-ACK) codebook message for transmission, wherein the HARQ-ACK codebook message includes an indication of a number of HARQ-ACK bits associated with an individual DCI of the one or more DCI; and
facilitate transmission of the HARQ-ACK codebook message.

22. The UE of claim 21, wherein the HARQ-ACK codebook message includes one or more indications of discontinuous transmission (DTX), wherein the one or more indications are to indicate that the one or more DCI were received.

23. The UE of claim 22, wherein the one or more indications are to further indicate that one or more additional DCI were not received.

24. The UE of claim 23, wherein the HARQ-ACK codebook message does not include an indication of a number of HARQ-ACK bits for the one or more additional DCI that were not received.

25. The UE of claim 21, wherein the one or more DCI are a plurality of DCI, and wherein a last DCI of the plurality of DCI includes a resource allocation for HARQ-ACK feedback associated with one or more physical downlink shared channel (PDSCH) transmissions scheduled by the plurality of DCI.

26. The UE of claim 21, wherein the one or more DCI are to schedule one or more physical downlink shared channel (PDSCH) transmissions for transmission, and wherein the one or more processors are further configured to identify an additional DCI received after the one or more DCI.

27. The UE of claim 26, wherein the additional DCI is to schedule a physical uplink control channel (PUCCH) or a physical uplink shared channel (PUSCH) transmission that is to carry HARQ-ACK feedback related to the one or more PDSCH transmissions.

28. The UE of claim 21, wherein the one or more DCI includes at least two DCIs that are to schedule a same physical uplink control channel (PUCCH) or physical uplink shared channel (PUSCH) transmission as one another.

29. The UE of claim 21, wherein the HARQ-ACK codebook is related to a counter downlink assignment index (C-DAI) field in a DCI of the one or more DCI.

30. The UE of claim 29, wherein the HARQ-ACK codebook may include an indication of received or unreceived C-DAIs in the one or more DCIs.

31. One or more non-transitory computer-readable media comprising instructions that, upon execution of the instructions by one or more processors of a user equipment (UE) of a cellular network, are to cause the UE to:
identify a downlink control information (DCI) received via a physical downlink control channel (PDCCH) transmission;
decode, based on the DCI, one or more physical downlink shared channel (PDSCH) transmissions, wherein the one or more PDSCH transmissions are scheduled by the DCI;
generate hybrid automatic repeat request acknowledgement (HARQ-ACK) information related to the one or more PDSCH transmissions;
generate a HARQ-ACK codebook based on the HARQ-ACK information; and
facilitate transmission of the HARQ-ACK codebook.

32. The one or more non-transitory computer-readable media of claim 31, wherein the HARQ-ACK codebook includes a first sub-codebook and a second sub-codebook.

33. The one or more non-transitory computer-readable media of claim 32, wherein the first sub-codebook includes HARQ-ACK information related to PDSCH transmissions scheduled by a DCI that schedules a single PDSCH.

34. The one or more non-transitory computer-readable media of claim 32, wherein the second sub-codebook includes HARQ-ACK information for PDSCH transmissions other than the PDSCH transmissions scheduled by a DCI that schedules a single PDSCH.

35. The one or more non-transitory computer-readable media of claim 32, wherein the second sub-codebook includes HARQ-ACK information related to PDSCH transmissions scheduled by a DCI that schedules a plurality of PDSCH transmissions.

36. The one or more non-transitory computer-readable media of claim 32 wherein the first sub-codebook includes HARQ-ACK information related to a DCI for a serving cell configured transport block (TB)-based PDSCh transmission and single-PDSCH scheduling.

37. The one or more non-transitory computer-readable media of claim 32, wherein the first sub-codebook includes HARQ-ACK information related to a fallback DCI on a serving cell configured with codebook group (CBG)-based transmission or multi-PDSCH scheduling.

38. The one or more non-transitory computer-readable media of claim 32, wherein the first sub-codebook includes HARQ-ACK information related to a multi-PDSCH DCI that schedules a single PDSCH.

39. The one or more non-transitory computer-readable media of claim 32, wherein the first sub-codebook includes HARQ-ACK information related to a DCI that triggers a semi-persistent scheduling (SPS) PDSCH release.

40. The one or more non-transitory computer-readable media of claim 32, wherein the first sub-codebook includes HARQ-ACK information related to a DCI cell that indicates dormancy of a secondary cell (SCell).
